(19) United States
(12) Patent Application Publication
(10) Pub. No.: US 2024/0188088 A1
(43) Pub. Date: Jun. 6, 2024

(54) UPLINK CONTROL INFORMATION CARRIER SWITCH

(71) Applicant: QUALCOMM Incorporated, San Diego, CA (US)

(72) Inventors: Yi HUANG, San Diego, CA (US); Jing SUN, San Diego, CA (US); Konstantinos DIMOU, New York, NY (US); Seyedkianoush HOSSEINI, San Diego, CA (US); Tingfang JI, San Diego, CA (US)

(21) Appl. No.: 18/553,115

(22) PCT Filed: May 11, 2022
(86) PCT No.: PCT/US22/28808

§ 371 Date: Sep. 28, 2023

(30) Foreign Application Priority Data
May 11, 2021 (GR) 20210100318

(51) Int. Cl. H04W 72/21; H04L 5/00; H04W 72/1273; H04W 76/20

(52) U.S. Cl. CPC H04W 72/21; H04L 5/001; H04W 72/1273; H04W 76/20

(57) ABSTRACT

Aspects relate to component carriers that are associated with an uplink control channel group. In some examples, data may be communicated on one of the component carriers and feedback for the data may be communicated on another one of the component carriers.

### CROSS-REFERENCE TO RELATED APPLICATION(S)

The present application for patent claims priority to and the benefit of pending Greece Patent Application No. 20210100318, titled “UPLINK CONTROL INFORMATION CARRIER SWITCH” filed May 11, 2021, and assigned to the assignee hereof and hereby expressly incorporated by reference herein as if fully set forth below in its entirety and for all applicable purposes.

### TECHNICAL FIELD

The technology discussed below relates generally to wireless communication and, more particularly, to switching the transmission of uplink control information between different carriers.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell. In some examples, the base station may send downlink control information (DCI) to a UE, where the DCI identifies the resources to be used for a downlink transmission to a UE or an uplink transmission from a UE, as well as other information that the UE can use to receive the downlink transmission or transmit the uplink transmission.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include a transceiver, a memory, and a processor coupled to the transceiver and the memory. The processor and the memory may be configured to receive data on a first component carrier of a plurality of component carriers. In some examples, the plurality of component carriers is associated with an uplink control channel group. The processor and the memory may also be configured to receive a first indication that the user equipment is allowed to transmit feedback for the data on a second component carrier of the plurality of component carriers.

In some examples, a method for wireless communication at a user equipment is disclosed. The method may include receiving data on a first component carrier of a plurality of component carriers. In some examples, the plurality of component carriers is associated with an uplink control channel group. The method may also include receiving a first indication that the user equipment is allowed to transmit feedback for the data on a second component carrier of the plurality of component carriers.

In some examples, a user equipment may include means for receiving data on a first component carrier of a plurality of component carriers. In some examples, the plurality of component carriers is associated with an uplink control channel group. The user equipment may also include means for receiving a first indication that the user equipment is allowed to transmit feedback for the data on a second component carrier of the plurality of component carriers.

In some examples, an article of manufacture for use by a user equipment includes a non-transitory computer-readable medium having stored therein instructions executable by one or more processors of the user equipment to receive data on a first component carrier of a plurality of component carriers. In some examples, the plurality of component carriers is associated with an uplink control channel group. The computer-readable medium may also have stored therein instructions executable by the one or more processors of the user equipment to receive a first indication that the user equipment is allowed to transmit feedback for the data on a second component carrier of the plurality of component carriers.

In some examples, a network entity may include a transceiver, a memory, and a processor coupled to the transceiver and the memory. The processor and the memory may be configured to transmit data to a user equipment on a first component carrier of a plurality of component carriers. In some examples, the plurality of component carriers is associated with an uplink control channel group. The processor and the memory may also be configured to transmit a first indication that the user equipment is allowed to transmit feedback for the data on a second component carrier of the plurality of component carriers.

In some examples, a method for wireless communication at a network entity is disclosed. The method may include transmitting data to a user equipment on a first component carrier of a plurality of component carriers. In some examples, the plurality of component carriers is associated with an uplink control channel group. The method may also include transmitting a first indication that the user equipment is allowed to transmit feedback for the data on a second component carrier of the plurality of component carriers.

In some examples, a network entity may include means for transmitting data to a user equipment on a first component carrier of a plurality of component carriers. In some examples, the plurality of component carriers is associated with an uplink control channel group. The network entity may also include means for transmitting a first indication that the user equipment is allowed to transmit feedback for the data on a second component carrier of the plurality of component carriers.

In some examples, an article of manufacture for use by a network entity includes a non-transitory computer-readable medium having stored therein instructions executable by one or more processors of the network entity to transmit data to a user equipment on a first component carrier of a plurality of component carriers. In some examples, the plurality of component carriers is associated with an uplink control channel group. The computer-readable medium may also have stored therein instructions executable by the one or more processors of the network entity to transmit a first indication that the user equipment is allowed to transmit feedback for the data on a second component carrier of the plurality of component carriers.

In some examples, a user equipment may include a transceiver, a memory, and a processor coupled to the transceiver and the memory. The processor and the memory may be configured to receive data on a first component carrier of a plurality of component carriers. In some examples, the plurality of component carriers is associated with an uplink control channel group. The processor and the memory may also be configured to receive a first resource allocation. In some examples, the first resource allocation is for transmission of feedback for the data on the first component carrier. The processor and the memory may further be configured to receive a second resource allocation. In some examples, the second resource allocation is for transmission of the feedback for the data on a second component carrier of the plurality of component carriers.

In some examples, a method for wireless communication at a user equipment is disclosed. The method may include receiving data on a first component carrier of a plurality of component carriers. In some examples, the plurality of component carriers is associated with an uplink control channel group. The method may also include receiving a first resource allocation. In some examples, the first resource allocation is for transmission of feedback for the data on the first component carrier. The method may further include receiving a second resource allocation. In some examples, the second resource allocation is for transmission of the feedback for the data on a second component carrier of the plurality of component carriers.

In some examples, a user equipment may include means for receiving data on a first component carrier of a plurality of component carriers. In some examples, the plurality of component carriers is associated with an uplink control channel group. The user equipment may also include means for receiving a first resource allocation. In some examples, the first resource allocation is for transmission of feedback for the data on the first component carrier. The user equipment may further include means for receiving a second resource allocation. In some examples, the second resource allocation is for transmission of the feedback for the data on a second component carrier of the plurality of component carriers.

In some examples, an article of manufacture for use by a user equipment includes a non-transitory computer-readable medium having stored therein instructions executable by one or more processors of the user equipment to receive data on a first component carrier of a plurality of component carriers. In some examples, the plurality of component carriers is associated with an uplink control channel group. The computer-readable medium may also have stored therein instructions executable by the one or more processors of the user equipment to receive a first resource allocation. In some examples, the first resource allocation is for transmission of feedback for the data on the first component carrier. The computer-readable medium may further have stored therein instructions executable by the one or more processors of the user equipment to receive a second resource allocation. In some examples, the second resource allocation is for transmission of the feedback for the data on a second component carrier of the plurality of component carriers.

In some examples, a network entity may include a transceiver, a memory, and a processor coupled to the transceiver and the memory. The processor and the memory may be configured to transmit data on a first component carrier of a plurality of component carriers. In some examples, the plurality of component carriers is associated with an uplink control channel group. The processor and the memory may also be configured to transmit a first resource allocation. In some examples, the first resource allocation is for transmission of feedback for the data on the first component carrier. The processor and the memory may further be configured to transmit a second resource allocation. In some examples, the second resource allocation is for transmission of the feedback for the data on a second component carrier of the plurality of component carriers.

In some examples, a method for wireless communication at a network entity is disclosed. The method may include transmitting data on a first component carrier of a plurality of component carriers. In some examples, the plurality of component carriers is associated with an uplink control channel group. The method may also include transmitting a first resource allocation. In some examples, the first resource allocation is for transmission of feedback for the data on the first component carrier. The method may further include transmitting a second resource allocation. In some examples, the second resource allocation is for transmission of the feedback for the data on a second component carrier of the plurality of component carriers.

In some examples, a network entity may include means for transmitting data on a first component carrier of a plurality of component carriers. In some examples, the plurality of component carriers is associated with an uplink control channel group. The network entity may also include means for transmitting a first resource allocation. In some examples, the first resource allocation is for transmission of feedback for the data on the first component carrier. The network entity may further include means for transmitting a second resource allocation. In some examples, the second resource allocation is for transmission of the feedback for the data on a second component carrier of the plurality of component carriers.

In some examples, an article of manufacture for use by a network entity includes a non-transitory computer-readable medium having stored therein instructions executable by one or more processors of the network entity to transmit data on a first component carrier of a plurality of component carriers. In some examples, the plurality of component carriers is associated with an uplink control channel group. The computer-readable medium may also have stored therein instructions executable by the one or more processors of the network entity to transmit a first resource allocation. In some examples, the first resource allocation is for transmission of feedback for the data on the first component carrier. The computer-readable medium may further have stored therein instructions executable by the one or more processors of the network entity to transmit a second resource allocation. In some examples, the second resource allocation is for transmission of the feedback for the data on a second component carrier of the plurality of component carriers.

In some examples, a user equipment may include a transceiver, a memory, and a processor coupled to the transceiver and the memory. The processor and the memory may be configured to receive data on a first component carrier of a plurality of component carriers. In some examples, the plurality of component carriers is associated with an uplink control channel group. The processor and the memory may also be configured to select a physical uplink control channel (PUCCH) resource on a second component carrier of the plurality of component carriers for transmitting feedback for the data. The processor and the memory may further be configured to, after the selection of the PUCCH resource on the second component carrier, selectively transmit the feedback in parallel with uplink information based on whether parallel uplink transmission is enabled.

In some examples, a method for wireless communication at a user equipment is disclosed. The method may include receiving data on a first component carrier of a plurality of component carriers. In some examples, the plurality of component carriers is associated with an uplink control channel group. The method may also include selecting a physical uplink control channel (PUCCH) resource on a second component carrier of the plurality of component carriers for transmitting feedback for the data. The method may further include, after the selecting the PUCCH resource on the second component carrier, selectively transmitting the feedback in parallel with uplink information based on whether parallel uplink transmission is enabled.

In some examples, a user equipment may include means for receiving data on a first component carrier of a plurality of component carriers. In some examples, the plurality of component carriers is associated with an uplink control channel group. The user equipment may also include means for selecting a physical uplink control channel (PUCCH) resource on a second component carrier of the plurality of component carriers for transmitting feedback for the data. The user equipment may further include means for, after the selecting the PUCCH resource on the second component carrier, selectively transmitting the feedback in parallel with uplink information based on whether parallel uplink transmission is enabled

In some examples, an article of manufacture for use by a user equipment includes a non-transitory computer-readable medium having stored therein instructions executable by one or more processors of the user equipment to receive data on a first component carrier of a plurality of component carriers. In some examples, the plurality of component carriers is associated with an uplink control channel group. The computer-readable medium may also have stored therein instructions executable by the one or more processors of the user equipment to select a physical uplink control channel (PUCCH) resource on a second component carrier of the plurality of component carriers for transmitting feedback for the data. The computer-readable medium may further have stored therein instructions executable by the one or more processors of the user equipment to, after the selection of the PUCCH resource on the second component carrier, selectively transmit the feedback in parallel with uplink information based on whether parallel uplink transmission is enabled.

In some examples, a network entity may include a transceiver, a memory, and a processor coupled to the transceiver and the memory. The processor and the memory may be configured to transmit data on a first component carrier of a plurality of component carriers. In some examples, the plurality of component carriers is associated with an uplink control channel group. The processor and the memory may also be configured to identify a physical uplink control channel (PUCCH) resource on a second component carrier of the plurality of component carriers for transmission of feedback for the data by a user equipment. The processor and the memory may further be configured to, after the identification of the PUCCH resource on the second component carrier, selectively receive the feedback in parallel with uplink information based on whether parallel uplink transmission is enabled.

In some examples, a method for wireless communication at a network entity is disclosed. The method may include transmitting data on a first component carrier of a plurality of component carriers. In some examples, the plurality of component carriers is associated with an uplink control channel group. The method may also include identifying a physical uplink control channel (PUCCH) resource on a second component carrier of the plurality of component carriers for transmission of feedback for the data by a user equipment. The method may further include, after the identifying the PUCCH resource on the second component carrier, selectively receiving the feedback in parallel with uplink information based on whether parallel uplink transmission is enabled.

In some examples, a network entity may include means for transmitting data on a first component carrier of a plurality of component carriers. In some examples, the plurality of component carriers is associated with an uplink control channel group, means for identifying a physical uplink control channel (PUCCH) resource on a second component carrier of the plurality of component carriers for transmission of feedback for the data by a user equipment, and means for, after the identifying the PUCCH resource on the second component carrier, selectively receiving the feedback in parallel with uplink information based on whether parallel uplink transmission is enabled.

In some examples, an article of manufacture for use by a network entity includes a non-transitory computer-readable medium having stored therein instructions executable by one or more processors of the network entity to transmit data on a first component carrier of a plurality of component carriers. In some examples, the plurality of component carriers is associated with an uplink control channel group. The computer-readable medium may also have stored therein instructions executable by the one or more processors of the network entity to identify a physical uplink control channel (PUCCH) resource on a second component carrier of the plurality of component carriers for transmission of feedback for the data by a user equipment. The computer-readable medium may also have stored therein instructions executable by the one or more processors of the network entity to, after the identification of the PUCCH resource on the second component carrier, selectively receive the feedback in parallel with uplink information based on whether parallel uplink transmission is enabled.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of wireless resources in an air interface utilizing orthogonal frequency divisional multiplexing (OFDM) according to some aspects.

FIG. 4 is a diagram providing a high-level illustration of one example of a configuration of a disaggregated base station according to some aspects.

FIG. 5 is a signaling diagram illustrating an example of physical downlink shared channel (PDSCH)-related signaling according to some aspects.

FIG. 6 is a conceptual illustration of an example of wireless communication via multiple radio frequency (RF) carriers according to some aspects.

FIG. 7 is a conceptual illustration of an example of physical uplink control channel (PUCCH) scheduling according to some aspects.

FIG. 8 is a conceptual illustration of an example of a PUCCH carrier switch according to some aspects.

FIG. 9 is a conceptual illustration of another example of a PUCCH carrier switch according to some aspects.

FIG. 10 is a conceptual illustration of another example of a PUCCH carrier switch according to some aspects.

FIG. 11 is a conceptual illustration of an example of a PUCCH carrier switch and parallel transmission according to some aspects.

FIG. 12 is a conceptual illustration of an example of a restricted PUCCH carrier switch according to some aspects.

FIG. 13 is a signaling diagram illustrating an example of PDSCH-related signaling according to some aspects.

FIG. 14 is a block diagram conceptually illustrating an example of a hardware implementation for a user equipment employing a processing system according to some aspects.

FIG. 15 is a flow chart illustrating an example wireless communication method relating to feedback transmission according to some aspects.

FIG. 16 is a flow chart illustrating an example wireless communication method relating to resource allocation for feedback transmission according to some aspects.

FIG. 17 is a flow chart illustrating an example wireless communication method relating to PUCCH resources for feedback transmission according to some aspects.

FIG. 18 is a flow chart illustrating an example wireless communication method relating to selective feedback transmission according to some aspects.

FIG. 19 is a block diagram conceptually illustrating an example of a hardware implementation for a network entity employing a processing system according to some aspects.

FIG. 20 is a flow chart illustrating an example wireless communication method relating to feedback transmission according to some aspects.

FIG. 21 is a flow chart illustrating an example wireless communication method relating to resource allocation for feedback transmission according to some aspects.

FIG. 22 is a flow chart illustrating an example wireless communication method relating to PUCCH resources for feedback transmission according to some aspects.

FIG. 23 is a flow chart illustrating an example wireless communication method relating to selective feedback reception according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to dynamically selecting a component carrier to be used to transmit uplink control information. This selection process may be referred to as an uplink control information carrier switch. For example, to enable uplink control information such as physical uplink control channel (PUCCH) feedback to be transmitted as soon as possible (e.g., for time sensitive communication such as Enhanced Industrial Internet of Things (IIOT) traffic and/or ultra-reliable low-latency communication (URLLC) traffic), a UE may transmit the uplink control information on a different carrier than the carrier that was used to receive the data for which the feedback is being sent.

In an uplink carrier aggregation configuration, a UE may receive data from a network entity such as a base station on a physical downlink shared channel (PDSCH) of a primary component carrier during a particular slot. In addition, the UE may be instructed (e.g., via downlink control information) to transmit hybrid automatic repeat request (HARQ) ACK/NAK feedback in a subsequent slot. In scenarios where an uplink or special slot is not available on the primary component carrier for several slots, it may be beneficial to instead transmit the HARQ ACK/NAK feedback on a secondary component carrier that is configured with an earlier uplink or special slot.

Such an uplink control information (e.g., PUCCH) carrier switch may be configured in different ways in different examples. In some examples, each component carrier may be independently configured (e.g., by radio resource control (RRC) signaling) for uplink control information carrier switching. In some examples, the uplink resources for each component carrier may be independently configured (e.g., by RRC signaling) for uplink control information carrier switching.

Parallel uplink transmissions may be enabled (e.g., configured) or not enabled (e.g., not configured) at a UE. In some examples (e.g., where the UE is configured to perform parallel uplink transmissions), the UE may first select a carrier for transmitting uplink control information, and then perform a PUCCH and physical uplink shared channel (PUSCH) parallel transmission. Similarly, in some examples (e.g., where the UE is configured to perform parallel uplink transmissions), the UE may first select a carrier for transmitting uplink control information, and then perform PUCCH and PUSCH multiplexing.

In some examples, a UE may prioritize a primary component carrier for transmission of uplink control information. For example, the UE may first determine whether the slot specified for transmission of feedback is available for uplink transmission on the primary component carrier (e.g., that slot on the primary component carrier is not scheduled for a downlink transmission). If the slot is available, the UE uses the primary component carrier to transmit the feedback. If the slot is not available on the primary component carrier, the UE uses a specified secondary component carrier to transmit the feedback if that slot on that component carrier is available for uplink transmission. In some examples, the UE is allowed to use only one secondary component carrier to transmit this feedback (i.e., the UE does not check to see if it can transmit the feedback on any other secondary component carriers).

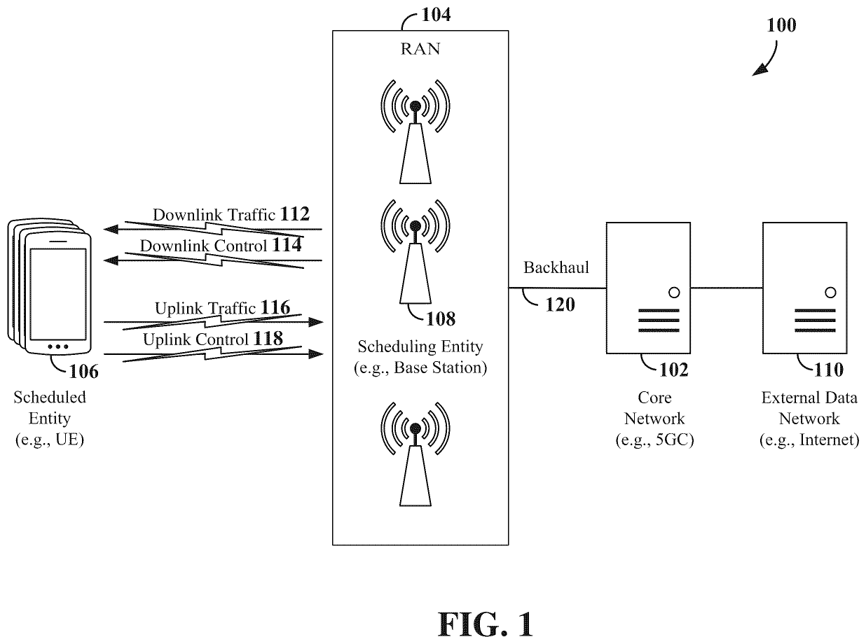

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network—New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IOT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

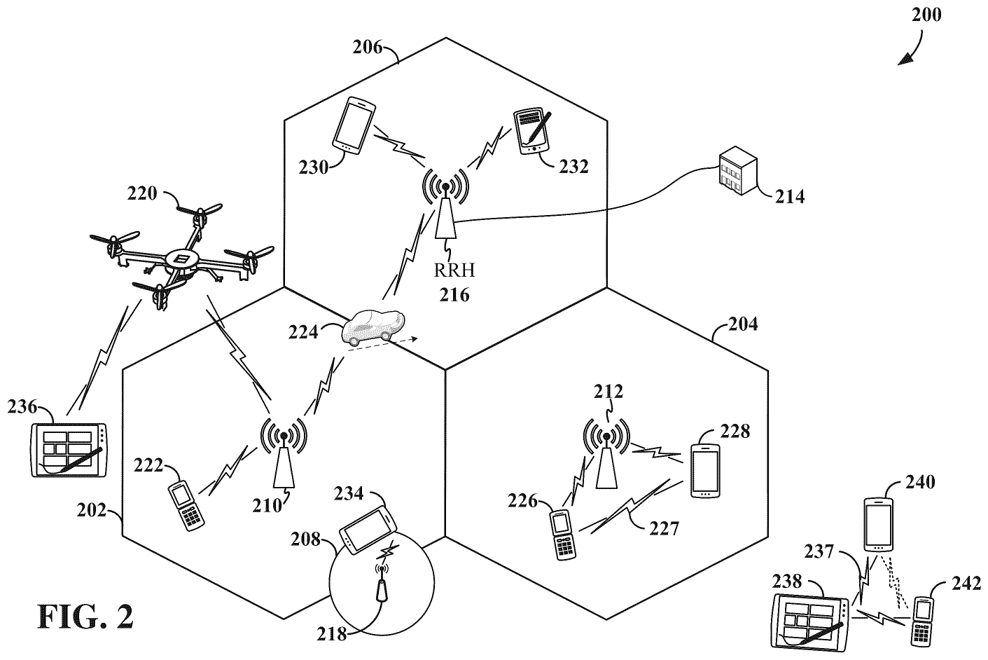

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

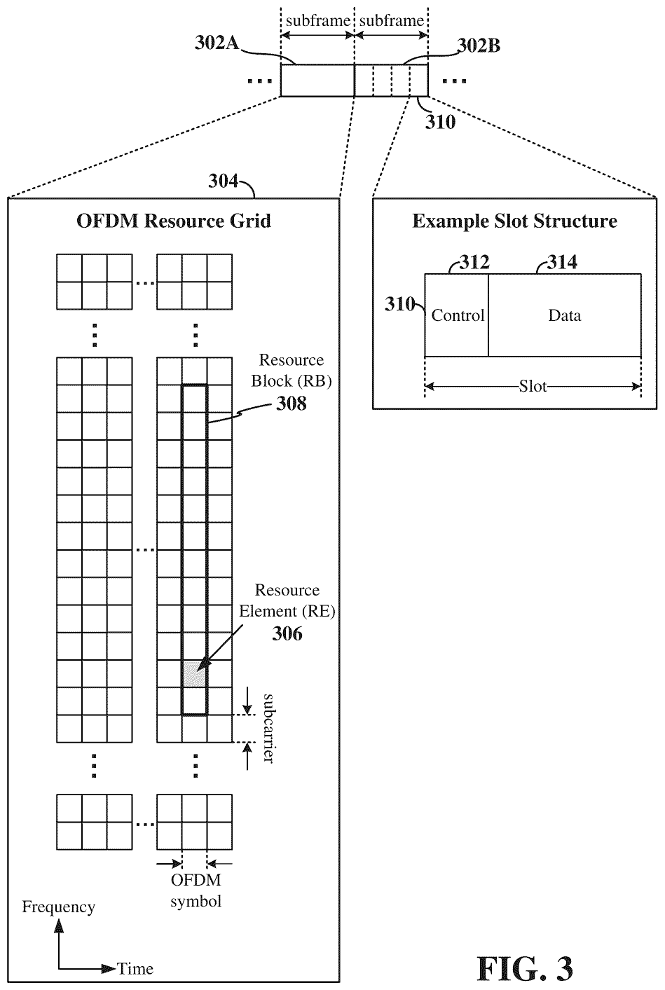

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example subframe 302 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely an example, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

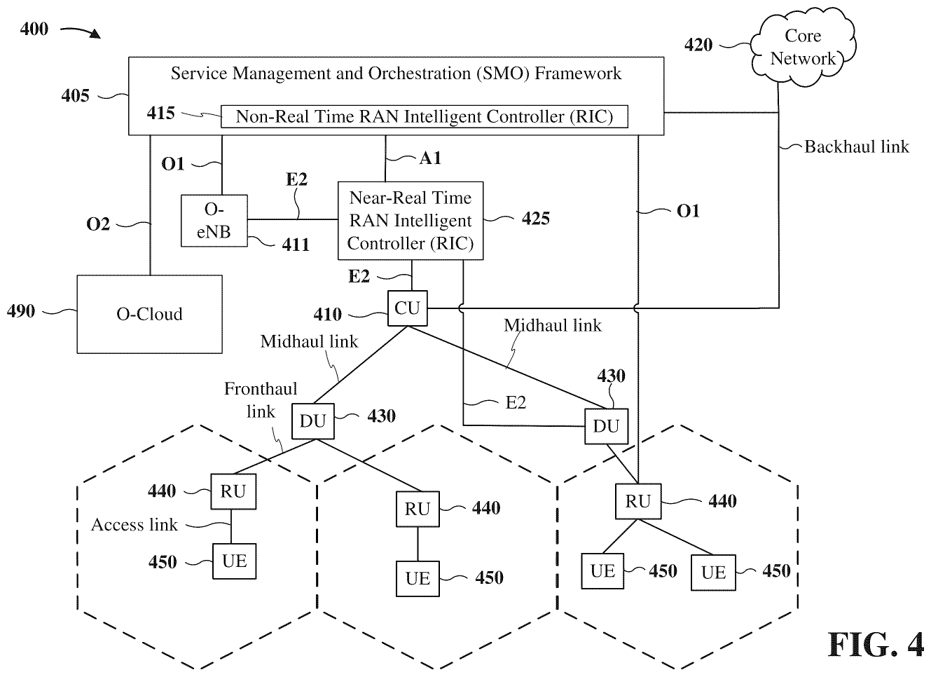

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUS) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the distributed unit (DU) 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via 01) or via creation of RAN management policies (such as A1 policies).

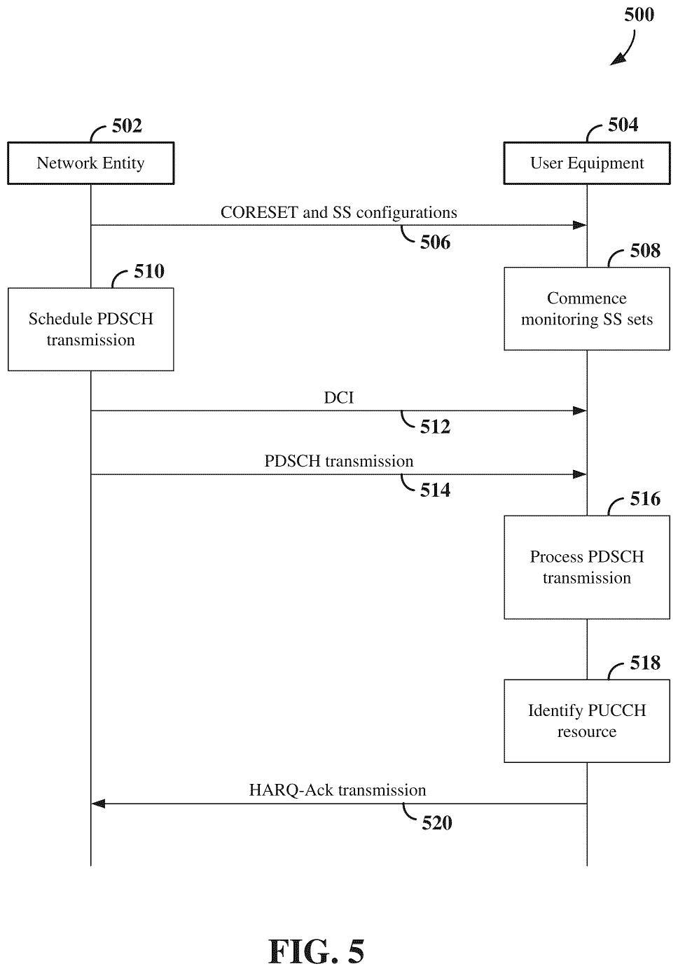

FIG. 5 is a signaling diagram 500 illustrating an example of PDSCH-related-related signaling in a wireless communication system including a network entity 502 and a user equipment (UE) 504. In some examples, the network entity 502 may correspond to any of the base stations, CUs, DUs, RUs, or scheduling entities shown in any of FIGS. 1, 2, 4, 6, 13, and 19. In some examples, the UE 504 may correspond to any of the UEs or scheduled entities shown in any of FIGS. 1, 2, 4, 6, 13, and 14.

At 506 of FIG. 5, the network entity 502 transmits (e.g., via RRC messaging) CORESET and SS configurations that the UE 504 is to use for receiving information from the network entity 502. For example, a CORESET configuration for the UE may specify the RBs and the number of symbols for each CORESET configured for the UE 504. In addition, a search space (SS) configuration may specify, for each configured SS set, the associated CORESET, PDCCH monitoring occasion (MO) information, PDCCH candidates, and so on.

At 508, the UE 504 repeatedly monitors the configured SS sets to determine whether the network entity 502 has transmitted any messages to the UE 504. In some aspects, this may involve blind decoding for PDCCH candidates in a search space configured for the UE 504.

At 510, at some point in time, the network entity 502 schedules a PDSCH transmission for the UE 504. In some examples, the network entity 502 may schedule a PDSCH transmission and an associated PUCCH transmission (e.g., for a HARQ-Ack). Accordingly, at 512, the network entity 502 transmits a DCI to the UE 504, where the DCI may indicate a PDSCH resource for the PDSCH transmission and a PUCCH resource for a HARQ-Ack. At 514, the network entity 502 transmits the PDSCH transmission to the UE 504.

At 516, the UE 504 attempts to decode the PDSCH transmission and generates a HARQ-Ack to be sent to the network entity 502 to indicate whether the UE 504 successfully received the PDSCH transmission. Thus, at 518, the UE 504 will identify the PUCCH resource for sending the HARQ-Ack to the network entity 502 (e.g., based on information in the DCI received at 512). At 520, the UE 504 transmits the HARQ-Ack transmission on the PUCCH resource identified at 518.

5G-NR networks may support carrier aggregation (CA) of component carriers transmitted from different cells and/or different transmission and reception points (TRPs) in a multi-cell transmission environment. The different TRPs may be associated with a single serving cell or multiple serving cells. In some aspects, the term component carrier may refer to a carrier frequency (or band) utilized for communication within a cell.

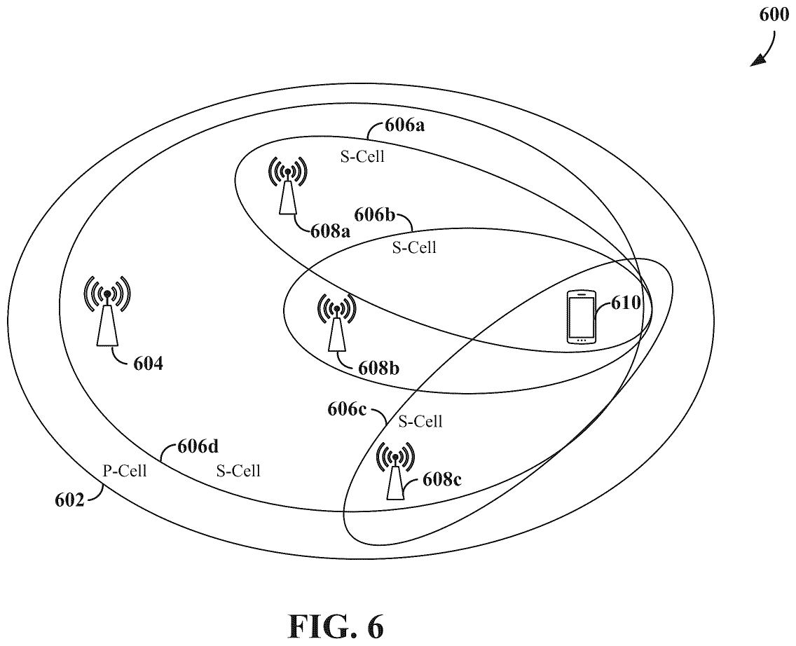

FIG. 6 is a conceptual illustration of a wireless communication system that shows a network entity (e.g., a BS) and a user equipment (UE) communicating via multiple carriers according to some aspects of the disclosure. In particular, FIG. 6 shows an example of a wireless communication system 600 that includes a primary serving cell (PCell) 602 and one or more secondary serving cells (SCells) 606a, 606b, 606c, and 606d. The PCell 602 may be referred to as the anchor cell that provides a radio resource control (RRC) connection to the UE 610. In some examples, the PCell and the SCell may be co-located (e.g., different TRPs at the same location). In some examples, the UE 610 may correspond to any of the UEs or scheduled entities shown in any of FIGS. 1, 2, 4, 5, 13, and 14.

One or more of the SCells 606a-606d may be activated or added to the PCell 602 to form the serving cells serving the UE 610. Each serving cell corresponds to a component carrier (CC). The CC of the PCell 602 may be referred to as a primary CC, and the CC of an SCell 606a-606d may be referred to as a secondary CC. The PCell 602 and one or more of the SCells 606 may be served by a respective base station 604 and 608a-608c similar to any of the network entities, base stations, CUs, DUs, RUs, or scheduling entities shown in any of FIGS. 1, 2, 4, 5, 13, and 19. In the example shown in FIG. 6, SCells 606a-606c are each served by a respective base station 608a-608c. SCell 606d is co-located with the PCell 602. For example, the base station 604 may include multiple TRPs, each supporting a different carrier. The coverages of the PCell 602 and SCell 606d may differ since component carriers in different frequency bands may experience different path loss.

In some examples, the PCell 602 may add or remove one or more of the SCells 606a-606d to improve reliability of the connection to the UE 610 and/or increase the data rate. The PCell 602 may be changed upon a handover to another PCell.

In some examples, the PCell 602 may utilize a first radio access technology (RAT), such as LTE, while one or more of the SCells 606 may utilize a second RAT, such as 5G-NR. In this example, the multi-cell transmission environment may be referred to as a multi-RAT-dual connectivity (MR-DC) environment. One example of MR-DC is Evolved-Universal Terrestrial Radio Access Network (E-UTRAN)-New Radio (NR) dual connectivity (EN-DC) mode that enables a UE to simultaneously connect to an LTE base station and a NR base station to receive data packets from and send data packets to both the LTE base station and the NR base station.

In some examples, the PCell 602 may be a low band cell, and the SCells 606 may be high band cells. A low band (LB) cell uses a CC in a frequency band lower than that of the high band cells. For example, the high band cells may use millimeter wave (mmW) CC, and the low band cell may use a CC in a band (e.g., sub-6 GHZ band) lower than mmW. In general, a cell using a mmW CC can provide greater bandwidth than a cell using a low band CC. In addition, when using a frequency carrier that is above 6 GHZ (e.g., mmW), beamforming may be used to transmit and receive signals in some examples.

The disclosure relates in some aspects to physical layer feedback techniques. In some examples, these techniques may provide improved feedback that can, for example, meet Enhanced Industrial Internet of Things (IIOT) requirements and ultra-reliable low-latency communication (URLLC) requirements. In some examples, this feedback may relate to PUCCH carrier switching for HARQ feedback.

In some wireless communication networks, PUCCH is transmitted only on a primary component carrier (PCC) or a PUCCH secondary component carrier (SCC) in a PUCCH group in uplink (UL) carrier aggregation (CA). This restriction may impose unnecessary extra latency and reliability reduction, especially in TDD spectrum.

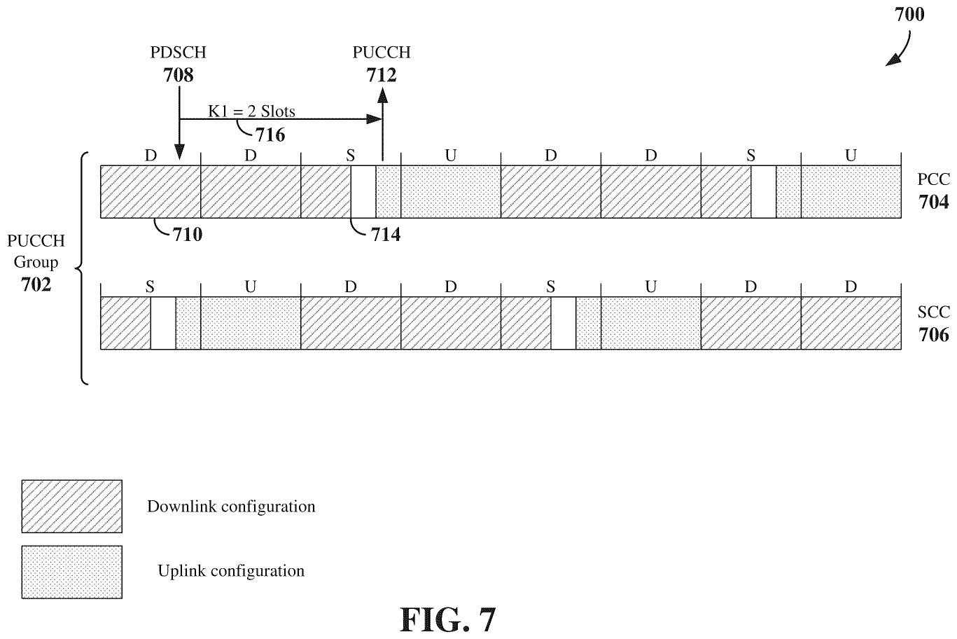

The diagram 700 of FIG. 7 illustrates an example of PDSCH scheduling in a PUCCH group 702 that includes a PCC 704 and an SCC 706. As shown in FIG. 7, slots on the PCC 704 and the SCC 705 may be designated (e.g., configured) as downlink (D) slots, uplink (U) slots, or special (S) slots (e.g., that can carry uplink and/or downlink signaling). A PDSCH transmission 708 occurs during a slot 710 on the PCC 804 and an associated PUCCH transmission 712 (e.g., HARQ-Ack) occurs during a slot 714 on the PCC 804. In addition, the parameter K1 included in the DCI that scheduled the PDSCH transmission 708 specifies a delay of 2 slots 716.

As shown in FIG. 7, in an example of TDD+FDD CA, for the PDSCH in the first DL slot (slot 710), a UE has to wait until the “S” slot (slot 714) to feedback HARQ-ACK in PUCCH at the earliest since HARQ-ACK can only be transmitted on PUCCH. Here, the slot to transmit HARQ-ACK is indicated by the K1 parameter in the DCI that scheduled the PDSCH. Since K1=2 in this example, the earliest the UE can transmit the HARQ-ACK is the during the UL portion of the indicated special (S) slot.

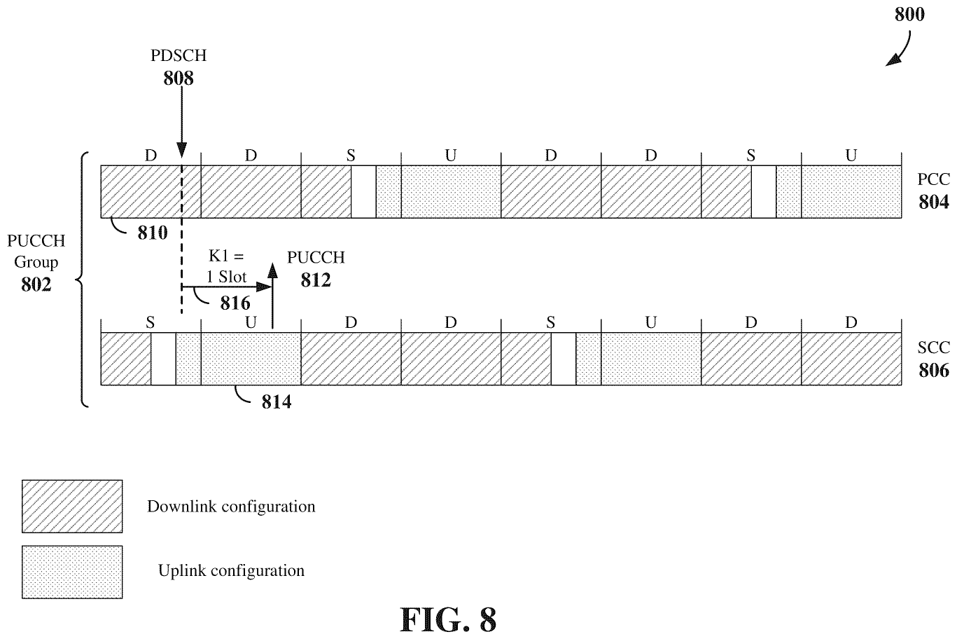

However, if the restriction of allowing PUCCH only on PCC is lifted, HARQ-ACK can be fedback on any component carrier (CC) in a PUCCH group. Thus, in this case, a UE can feedback HARQ-ACK earlier by utilizing the PUCCH resources configured on other CCs, which can reduce the HARQ-ACK delay (e.g., for URLLC, etc.), as shown in FIG. 8. Moreover, by allowing the UE to switch the CC used for HARQ-ACK, the UE may select a CC with more reliability.

The diagram 800 of FIG. 8 illustrates an example of PDSCH scheduling in a PUCCH group 802 that includes a PCC 804 and an SCC 806. As shown in FIG. 8, slots on the PCC 804 and the SCC 806 may be designated as downlink (D) slots, uplink (U) slots, or special (S) slots. A PDSCH transmission 808 occurs during a slot 810 on the PCC 804 and an associated PUCCH transmission 812 (e.g., HARQ-Ack) occurs during a slot 814 on the SCC 806. In this case, the parameter K1 included in the DCI that scheduled the PDSCH transmission 708 may specify a shorter delay of 1 slot 816.

Thus, a PUCCH carrier switch scheme for HARQ-ACK may reduce HARQ-ACK feedback latency (e.g., for inter-band CA with unaligned sub frame numbers (SFNs)). Accordingly, in some aspects, a HARQ-ACK carrier switch may provide shorter latency and more reliability, which may be important in use cases such as URLLC and IIOT.

Various techniques may be used to indicate a PUCCH carrier switch for HARQ-ACK. In some examples, a PUCCH carrier switch may be indicated by a dynamic and explicit indication in DCI. In some examples, a PUCCH carrier switch may be indicated by implicit derivation based on certain static rules. The dynamic/explicit indication in DCI may have more flexibility. However, there may be reliability issues associated with such an indication. Because each DCI can update the carrier where the HARQ-ACK codebook is transmitted, if a DCI is not successfully received by a UE, the base station (e.g., gNB) does not know on which CC the HARQ-ACK is transmitted and, therefore, will perform multiple blind detections. With UCI multiplexing on PUSCH, the issue of an unsuccessfully received DCI may be more severe, if the dynamic/explicit indication is applied for this feature. In some aspects, this may be more problematic than ambiguity of a HARQ-ACK codebook size due to an unsuccessfully received DCI. For the HARQ-ACK codebook size issue, there is downlink assignment index (DAI) mechanism introduced to resolve this issue (e.g., at least for most of the scenarios, except for the scenario all DL DCIs on all DL CCs are missed in a monitoring occasion).

On the other hand, if the indication is based on certain static rules (e.g., implemented in a 3GPP RAN 1 specification), more robust performance may be achieved. With a PUCCH carrier switch, the following static rule may be applied in some examples to determine the CC to transmit HARQ-ACK, in a given slot: The lowest indexed CC which has enough UL OFDM symbols to accommodate the HARQ-ACK PUCCH resource is selected to transmit the HARQ-ACK.

With a PUCCH carrier switch, the slot to transmit HARQ-ACK follows the K1 indicated in the scheduling DCI, and the granularity of K1 follows the numerology of the PCC.

The following steps may be used in an example that uses the above static rule. Step 1: The UE follows K1 (referenced to PCC numerology) to determine a reference slot to feedback HARQ-ACK. Step 2: In the determined reference slot, the UE follows a predefined ordering of CCs (such as PCC first, then SCC-1, SCC-2). If the first CC has enough UL OFDM symbols to accommodate the indicated HARQ-ACK PUCCH resource, that CC is used to transmit the HARQ ACK. If the second CC does not have enough UL OFDM symbols to accommodate the indicated HARQ-ACK PUCCH resource, the UE checks the next CC to see whether that CC has enough UL OFDM symbols to accommodate the indicated HARQ-ACK PUCCH resource. If it does, the UE uses that CC to transmit the HARQ-ACK. This process may repeat until a CC with sufficient resources is identified. The determination of whether there are enough UL OFDM symbols may be similar to an SPS ACK/NAK (A/N) deferral procedure (e.g., deferral to the next slot) in some examples. In scenarios where different subcarrier spacings (SCSs) on different CCs are supported, in the determined reference slot, if a CC includes multiple slots that each have enough UL OFDM symbols to accommodate the HARQ-ACK PUCCH resource, the earliest slot in the set of multiple slots may be selected.

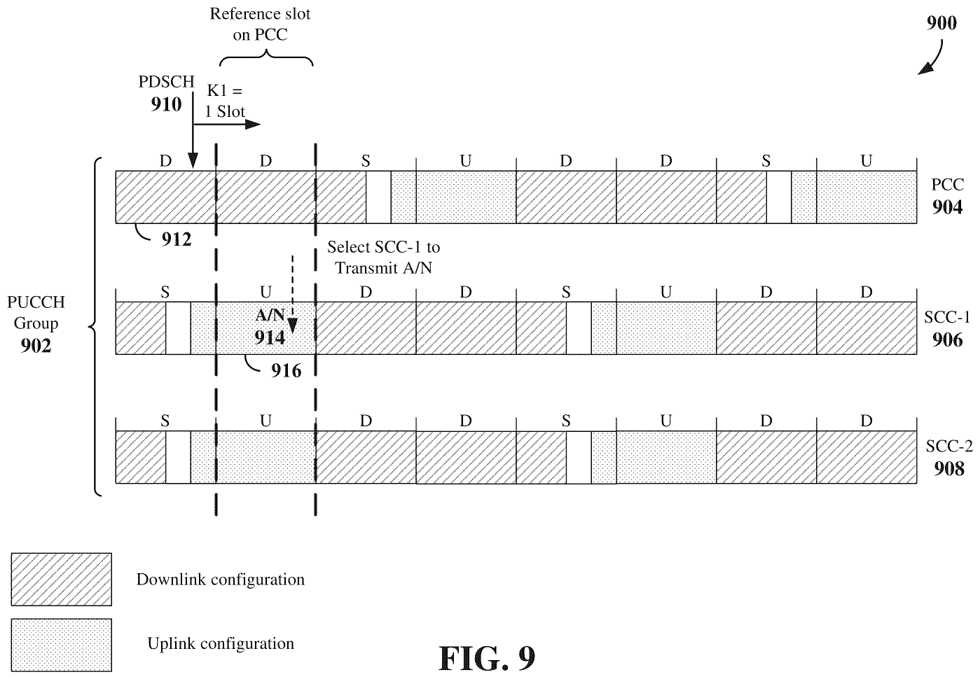

FIG. 9 illustrates an example of the above rule in the scenario of UL CA with the same numerology (SCS) on each carrier. Once the UE identifies the reference slot, the UE checks the allocations in the SCCs according to the defined order to identify an SCC that can be used to transmit the A/N. In this case, the UE transmits the A/N on SCC-1.

The diagram 900 of FIG. 9 illustrates an example of PDSCH scheduling in a PUCCH group 902 that includes a PCC 904, a first SCC (SCC-1) 906, and a second SCC (SCC-2) 908. As shown in FIG. 9, slots on the PCC 904, the first SCC 906, and the second SCC 908 may be designated as downlink (D) slots, uplink (U) slots, or special (S) slots. A PDSCH transmission 910 occurs during a slot 912 on the PCC 904 and an associated PUCCH transmission for A/N 914 (e.g., HARQ-Ack) occurs during a slot 916 on the first SCC 906.

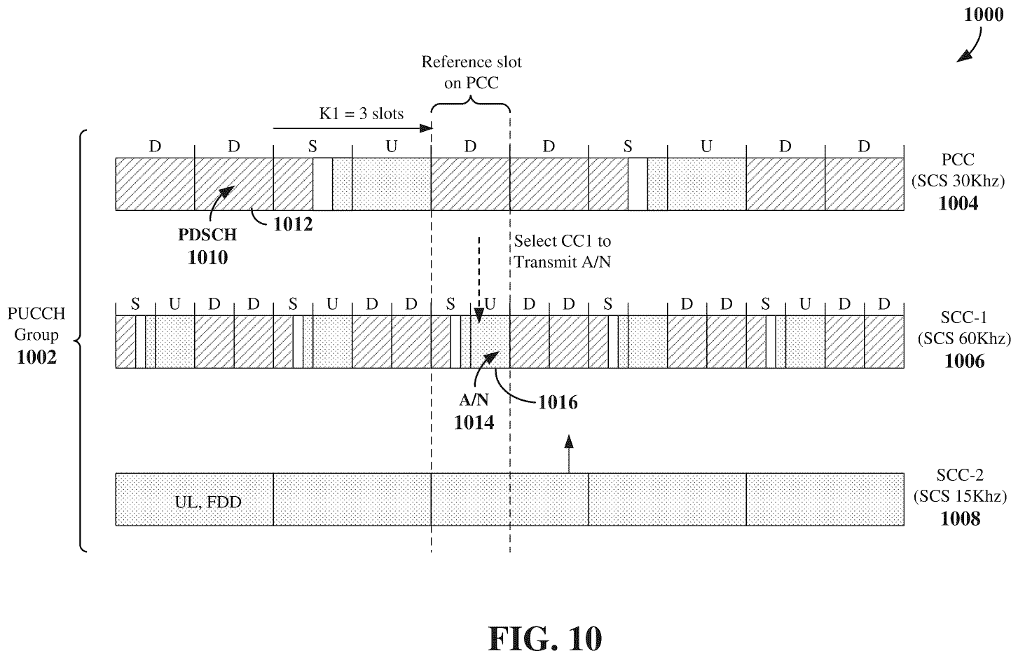

PUCCH carrier switch may be supported for UL CA with different numerologies (SCSs) across CCs. FIG. 10 illustrates an example of the above rule in the scenario of UL CA with different numerologies on different carriers. Once the UE identifies the reference slot, the UE checks the allocations in the SCCs according to the defined order to identify an SCC that can be used to transmit the A/N. In this case, the UE transmits the A/N on SCC-1. In some examples, within the reference slot (based on PCC numerology) indicated by K1, if multiple slots on a determined CC can be used to transmit the PUCCH, the earliest slot may be selected.

The diagram 1000 of FIG. 10 illustrates an example of PDSCH scheduling in a PUCCH group 1002 that includes a PCC 1004, a first SCC (SCC-1) 1006, and a second SCC (SCC-2) 1008. The SCS for the PCC 1004 is 30 kHz, the SCS for the first SCC 1006 is 60 kHz, and the SCS for the second SCC 1008 is 15 kHz in this example. As shown in FIG. 10, slots on the PCC 1004, the first SCC 1006, and the second SCC 1008 may be designated as downlink (D) slots, uplink (U) slots, or special (S) slots. A PDSCH transmission 1010 occurs during a slot 1012 on the PCC 1004 and an associated PUCCH transmission for A/N 1014 (e.g., HARQ-Ack) occurs during a slot 1016 on the first SCC 1006.

The disclosure relates in some aspects to PUCCH carrier switch configured by RRC per CC (e.g., as opposed to per UE). In this case, the base station (e.g., gNB) may have the flexibility to control which SCC can support PUCCH carrier switch based on whether some pre-requisite is satisfied or not. For example, an RRC configuration message may be used to enable/disable a feature on per CC basis. As one example, a gNB may restrict the PUCCH carrier switch across SCCs with the same PDSCH process capability (CAP1 vs CAP2) as PCC.

The disclosure relates in some aspects to PUCCH carrier switch where PUCCH resource sharing between a dynamic PUCCH resource (indicated by a PUCCH resource indicator (PRI) in DCI) and a configured PUCCH resource (by RRC) is not supported. For example, the slots with configured PUCCH resources may not be applicable to PUCCH carrier switching (e.g., as with an SPS A/N deferral). To support a unified design between SPS A/N deferral and PUCCH carrier switch, sharing of PUCCH resources between a dynamic PUCCH resource (indicated by PRI) and a semi-statically configured PUCCH resource (by RRC) may be indicated as being unsupported.

The disclosure relates in some aspects to configuring PUCCH resources per CC (e.g., as opposed to configuring the same PUCCH resources for all CCs). For example, PUCCH resources may be configured on per CC basis in scenarios where different CCs have different bandwidth. For example, a PCC may have a bandwidth of 100 RBs and an SCC may have a bandwidth of only 50 RBs. In this case, PUCCH resources can be configured on RBs in the range of [0,99] for PCC. For example, a PUCCH resource of 10 RBs spans from RB 90 to RB 99. However, the PUCCH resource configured for PCC cannot be used on the SCC in this example. Configuring PUCCH resources per CC may resolve this issue.

The disclosure relates in some aspects to specifying the interaction between PUCCH carrier switch, UCI multiplexing, and PUCCH/PUSCH parallel transmissions. In UCI multiplexing, if a UCI (PUCCH) transmission overlaps with a PUSCH transmission in the time domain, the UCI may be multiplexed with the PUSCH. For example, the original PUCCH transmission may be dropped, but the contents for that PUCCH transmission may be multiplexed with the PUSCH transmission. In PUCCH/PUSCH parallel transmissions, if a PUCCH transmission overlaps with a PUSCH transmission in the time domain, the two transmissions are performed at the same time.

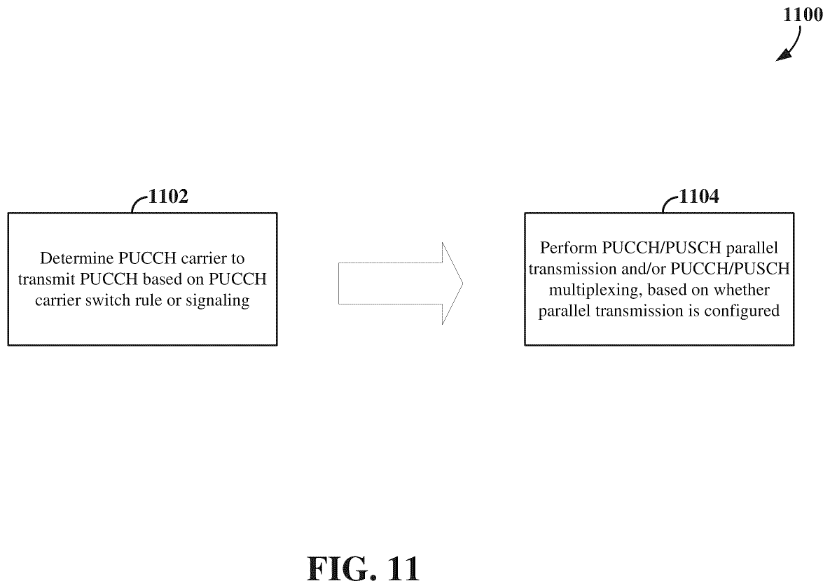

Referring to FIG. 11, as a first operation 1102, a UE performs a PUCCH carrier switch to determine on which CC/slot the PUCCH should be transmitted. After that, as a second operation 1104, the UE may perform either a parallel PUCCH/PUSCH transmission or a UCI multiplexing procedure (e.g., on the CC selected for the PUCCH carrier switch), depending on whether parallel transmission is enabled or not. The second operation 1104 of the procedure is the same regardless of whether the PUCCH carrier switch feature is supported or not. Also, even when the PUCCH carrier switch feature is enabled, the first operation 1102 (PUCCH carrier switch feature) can be effectively bypassed by a gNB via dynamically adjusting K1 values, if the gNB intends to do so.

The disclosure relates in some aspects to, in addition to PCC, allowing only one SCC to be configured to transmit PUCCH. In some examples, allowing one more carrier to transmit PUCCH is sufficient enough to obtain a desired level of latency reduction and diversity gain. By restricting the PUCCH carrier switch to only one SCC, the PUCCH carrier switch procedure may be more efficient. In some examples, an RRC message may be used to indicate this one SCC (e.g., by configuring the SCC index to be used). In some examples, an RRC message may carry a bit map that indicates for each SCC whether that SCC is enabled for PUCCH carrier switch.

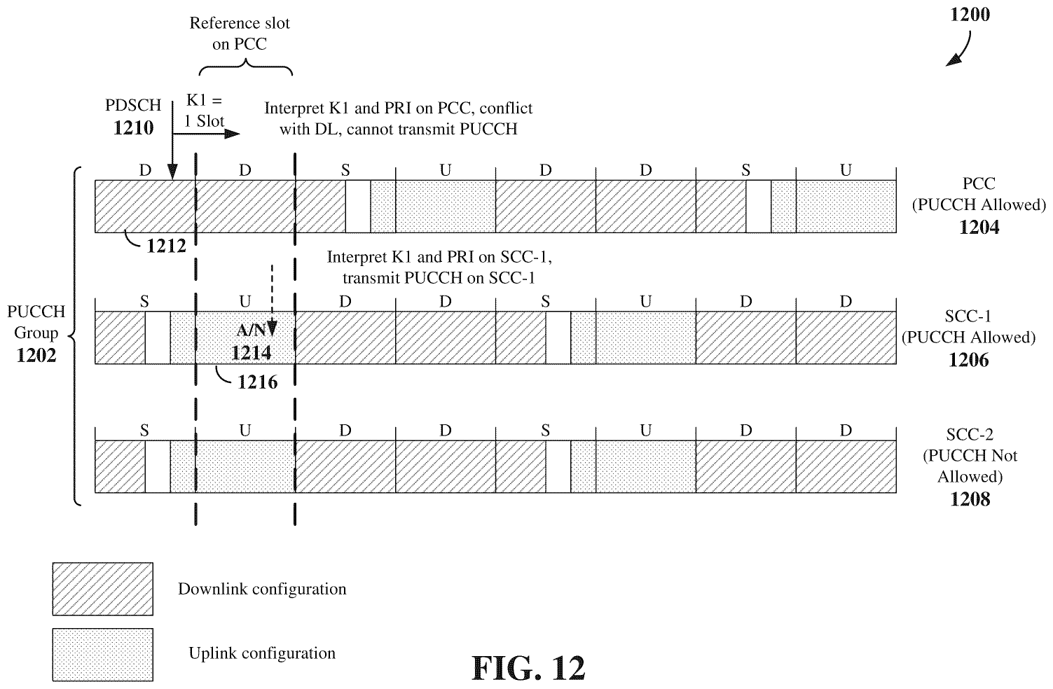

The disclosure relates in some aspects to prioritizing PCC for PUCCH carrier switching. On the UE side, the UE prioritizes the PCC by first interpreting K1 and PRI based on the PCC (e.g., using conventional techniques). If the interpreted slot and PUCCH resource on the PCC does not conflict with non-UL OFDM symbols (such as DL symbols, SSB symbols, CORESET0 symbols, etc.), the UE transmits the PUCCH on the PCC (e.g., without checking to see whether the single additionally configured SCC has earlier PUCCH resources available). Otherwise, the UE moves to the single additionally configured SCC (SCC-1 in the example shown in FIG. 12) and interprets K1 and PRI based on the numerology and PUCCH resource configuration on that SCC. It may be expected that the UE will find enough UL resources to transmit the PUCCH on that SCC, given that the PCC did not have available resources for the PUCCH transmission. For example, it may be deemed a gNB scheduling error if the UE cannot transmit the PUCCH on either PCC or the additional allowed PUCCH SCC.

It may be seen that this scheme may avoid the use of additional overhead in DCI, while achieving a suitable level of flexibility to dynamically indicate the PUCCH carrier between PCC and a SCC. Also, a UE may avoid scanning multiple CCs and checking UL OFDM symbols for every CC until it finds a legitimate CC to transmit the PUCCH. In the example of FIG. 12, the UE interprets the K1 and the PRI twice, once on the PCC and once on the allowed PUCCH SCC. Between the two interpretations, the interpretation on the PCC takes precedence.

The diagram 1200 of FIG. 12 illustrates an example of PDSCH scheduling in a PUCCH group 1202 that includes a PCC 1204, a first SCC (SCC-1) 1206, and a second SCC (SCC-2) 1208. In this example, PUCCH is allowed on the PCC 1204, PUCCH is allowed on the first SCC 1206, and PUCCH is not allowed on the second SCC 1208. As shown in FIG. 12, slots on the PCC 1204, the first SCC 1206, and the second SCC 1208 may be designated as downlink (D) slots, uplink (U) slots, or special (S) slots. A PDSCH transmission 1210 occurs during a slot 1212 on the PCC 1204 and an associated PUCCH transmission for A/N 1214 (e.g., HARQ-Ack) occurs during a slot 1216 on the first SCC 1206 (e.g., due to a conflict on the PCC 1204 where the preferred slot for transmitting the A/N is a downlink slot).

Thus, the disclosure relates in some aspects to an efficient PUCCH carrier switch that involves restricting the CCs allowed to transmit PUCCH to only one additional SCC. The UE interprets the K1 and the PRI parameters (or the RRC configured PUCCH resource indicator for an SPS A/N) twice, once for PCC and once for a configured allowed PUCCH SCC, with the PCC taking precedence.

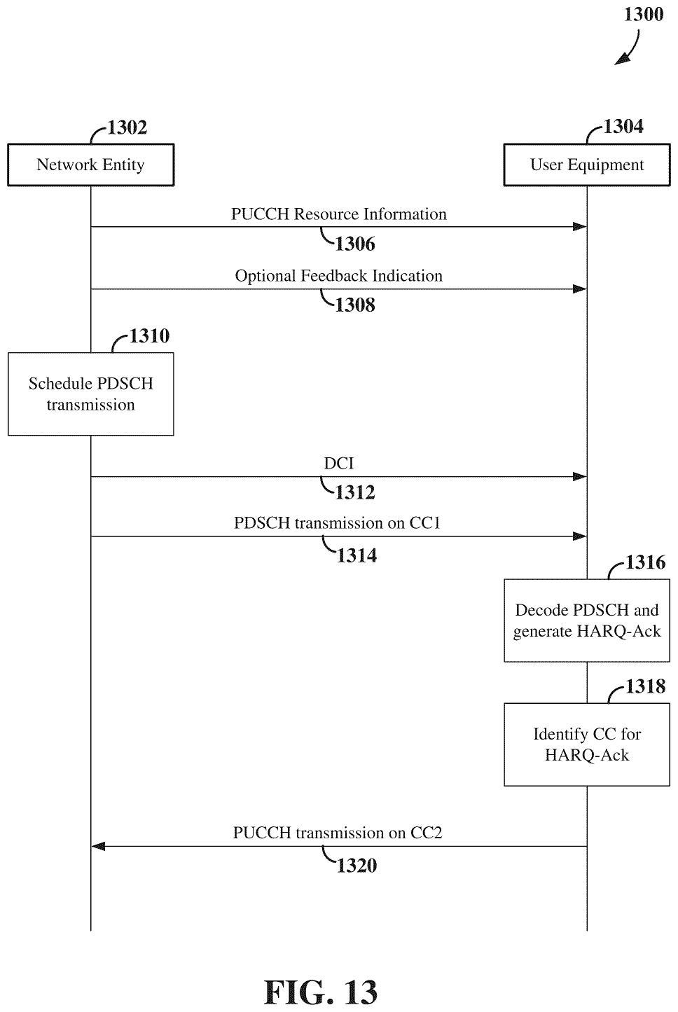

FIG. 13 is a signaling diagram 1300 illustrating an example of PDSCH-related signaling in a wireless communication system including a network entity 1302 and a user equipment (UE) 1304. In some examples, the network entity 1302 may correspond to any of the base stations, CUs, DUs, RUs, or scheduling entities shown in any of FIGS. 1, 2, 4, 5, 6, and 19. In some examples, the UE 1304 may correspond to any of the UEs or scheduled entities shown in any of FIGS. 1, 2, 4, 5, 6, and 14.

At 1306 of FIG. 13, the network entity 1302 transmits (e.g., via RRC messaging) resource information that the UE 1304 may use for transmitting a PUCCH. For example, the resource information may specify that a first set of RBs (e.g., 100 RBs) may be used for PUCCH transmission on a first CC (e.g., CC1) and a second set of RBs (e.g., 10 RBs) may be used for PUCCH transmission on a second CC (e.g., CC2).

At 1308, the network entity 1302 transmits (e.g., via RRC messaging) an indication of whether, for a data transmission on one CC, the UE 1304 is allowed to transmit feedback on another CC. For example, the indication may specify that data transmissions on a first CC (e.g., a PCC) may be acknowledged on a second CC (e.g., an SCC) and/or vice versa.

At 1310, at some point in time, the network entity 1302 schedules a PDSCH transmission for the UE 1304. In some examples, the network entity 1302 may schedule a PDSCH transmission and an associated PUCCH transmission (e.g., for a HARQ-Ack). Accordingly, at 1312, the network entity 1302 transmits a DCI to the UE 1304, where the DCI may indicate a PDSCH resource for the PDSCH transmission on a first CC (CC1) and a PUCCH resource for a HARQ-Ack on a second CC (CC2). At 1314, the network entity 1302 transmits the PDSCH transmission to the UE 1304 on CC1.

At 1316, the UE 1304 attempts to decode the PDSCH transmission. The UE 1304 then generates a HARQ-Ack to be sent to the network entity 1302 to indicate whether the UE 1304 successfully received the PDSCH transmission.

At 1318, the UE 1304 identifies a CC for sending the HARQ-Ack to the network entity 1302. For example, the UE 1304 may elect to send the HARQ-Ack on CC2 to provide a shorter feedback turn-around time than the feedback turn-around time that is possible on CC1. At 1320, the UE 1304 transmits the HARQ-Ack transmission on CC2.

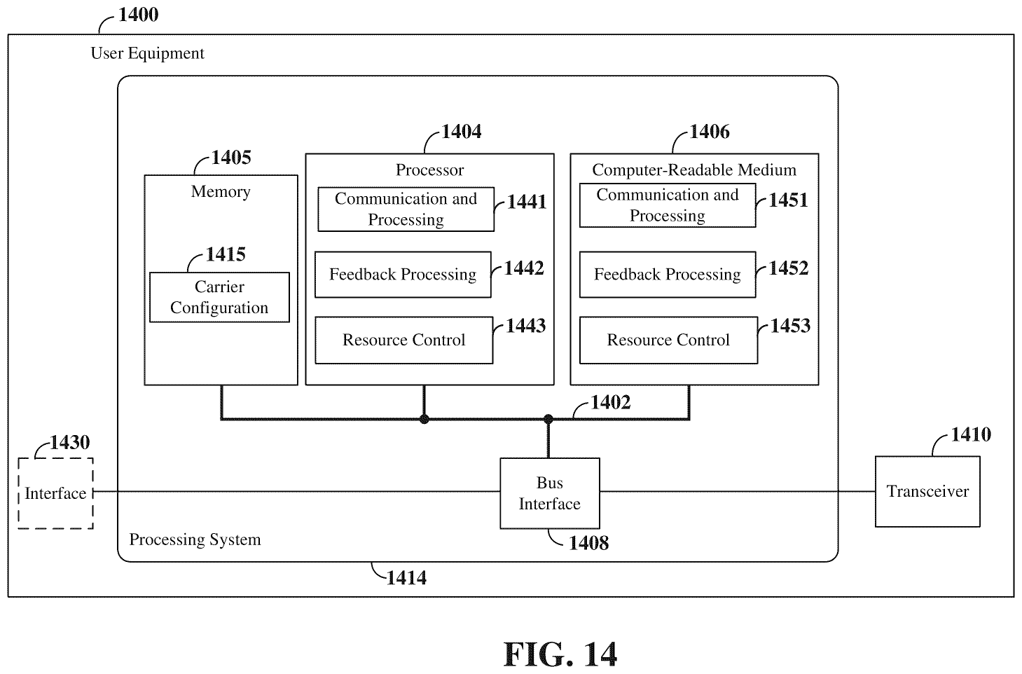

FIG. 14 is a block diagram illustrating an example of a hardware implementation for a UE 1400 employing a processing system 1414. For example, the UE 1400 may be a device configured to wirelessly communicate with a base station, as discussed in any one or more of FIGS. 1-13. In some implementations, the UE 1400 may correspond to any of the UEs or scheduled entities shown in any of FIGS. 1, 2, 4, 5, 6, and 13.

In accordance with various aspects of the disclosure, an element, or any portion of an element, or any combination of elements may be implemented with the processing system 1414. The processing system 1414 may include one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in a UE 1400, may be used to implement any one or more of the processes and procedures described herein.

The processor 1404 may in some instances be implemented via a baseband or modem chip and in other implementations, the processor 1404 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402 and a transceiver 1410 and between the bus 1402 and an interface 1430. The transceiver 1410 provides a communication interface or means for communicating with various other apparatus over a wireless transmission medium. The interface 1430 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1430 may include a user interface (e.g., keypad, display, speaker, microphone, joystick). Of course, such a user interface is optional, and may be omitted in some examples, such as an IoT device.

The processor 1404 is responsible for managing the bus 1402 and general processing, including the execution of software stored on the computer-readable medium 1406. The software, when executed by the processor 1404, causes the processing system 1414 to perform the various functions described below for any particular apparatus. The computer-readable medium 1406 and the memory 1405 may also be used for storing data that is manipulated by the processor 1404 when executing software. For example, the memory 1405 may store carrier configuration information 1415 (e.g., PCC and SCC information) used by the processor 1404 for communication operations as described herein.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1406.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

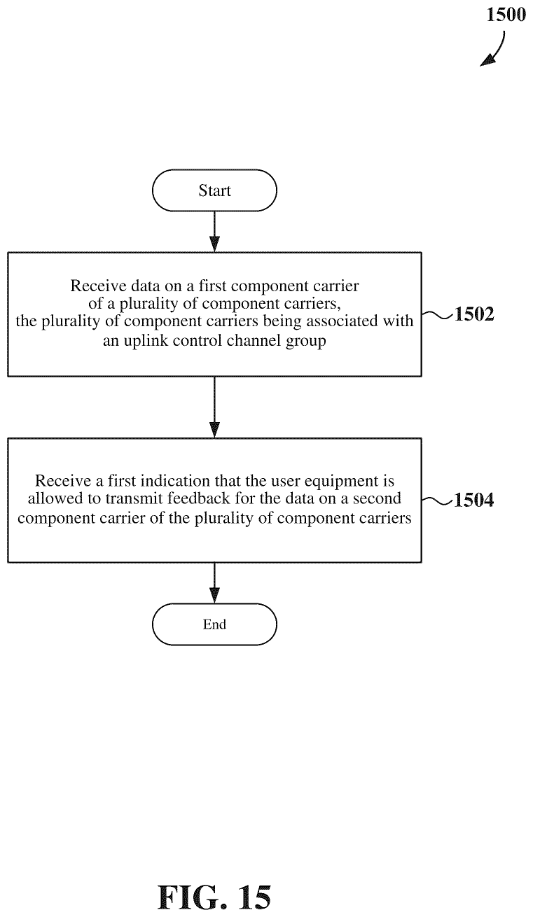

The UE 1400 may be configured to perform any one or more of the operations described herein (e.g., as described above in conjunction with FIGS. 1-13 and as described below in conjunction with FIGS. 15-18). In some aspects of the disclosure, the processor 1404, as utilized in the UE 1400, may include circuitry configured for various functions.

The processor 1404 may include communication and processing circuitry 1441. The communication and processing circuitry 1441 may be configured to communicate with a base station, such as a gNB. The communication and processing circuitry 1441 may include one or more hardware components that provide the physical structure that performs various processes related to wireless communication (e.g., signal reception and/or signal transmission) as described herein. The communication and processing circuitry 1441 may further include one or more hardware components that provide the physical structure that performs various processes related to signal processing (e.g., processing a received signal and/or processing a signal for transmission) as described herein. In some examples, the communication and processing circuitry 1441 may include two or more transmit/receive chains. The communication and processing circuitry 1441 may further be configured to execute communication and processing software 1451 included on the computer-readable medium 1406 to implement one or more functions described herein.

In some implementations where the communication involves receiving information, the communication and processing circuitry 1441 may obtain information from a component of the UE 1400 (e.g., from the transceiver 1410 that receives the information via radio frequency signaling or some other type of signaling suitable for the applicable communication medium), process (e.g., decode) the information, and output the processed information. For example, the communication and processing circuitry 1441 may output the information to another component of the processor 1404, to the memory 1405, or to the bus interface 1408. In some examples, the communication and processing circuitry 1441 may receive one or more of signals, messages, other information, or any combination thereof. In some examples, the communication and processing circuitry 1441 may receive information via one or more channels. In some examples, the communication and processing circuitry 1441 may include functionality for a means for receiving. In some examples, the communication and processing circuitry 1441 may include functionality for a means for decoding. In some examples, the communication and processing circuitry 1441 may include functionality for a means for receiving data on one or more component carriers.

In some implementations where the communication involves sending (e.g., transmitting) information, the communication and processing circuitry 1441 may obtain information (e.g., from another component of the processor 1404, the memory 1405, or the bus interface 1408), process (e.g., encode) the information, and output the processed information. For example, the communication and processing circuitry 1441 may output the information to the transceiver 1410 (e.g., that transmits the information via radio frequency signaling or some other type of signaling suitable for the applicable communication medium). In some examples, the communication and processing circuitry 1441 may send one or more of signals, messages, other information, or any combination thereof. In some examples, the communication and processing circuitry 1441 may send information via one or more channels. In some examples, the communication and processing circuitry 1441 may include functionality for a means for sending (e.g., a means for transmitting). In some examples, the communication and processing circuitry 1441 may include functionality for a means for encoding. In some examples, the communication and processing circuitry 1441 may include functionality for a means for transmitting feedback on one or more component carriers.

The processor 1404 may include feedback processing circuitry 1442 configured to perform feedback processing-related operations as discussed herein (e.g., one or more of the operations described above in conjunction with FIGS. 8-17). The feedback processing circuitry 1442 may be configured to execute feedback processing software 1452 included on the computer-readable medium 1406 to implement one or more functions described herein.

The feedback processing circuitry 1442 may include functionality for a means for receiving an indication that a UE is allowed to transmit feedback on another CC (e.g., as described above in conjunction with FIGS. 8-17). For example, the feedback processing circuitry 1442 together with the communication and processing circuitry 1441 and the transceiver 1410 may receive an RRC message on a PDSCH that includes the indication.

The processor 1404 may include resource control circuitry 1443 configured to perform resource control-related operations as discussed herein (e.g., one or more of the operations described above in conjunction with FIGS. 8-17). The resource control circuitry 1443 may be configured to execute resource control software 1453 included on the computer-readable medium 1406 to implement one or more functions described herein.

The resource control circuitry 1443 may include functionality for a means for selecting a resource. For example, the resource control circuitry 1443 may select one CC of a set of CCs for receiving a PUCCH.

The resource control circuitry 1443 may include functionality for a means for receiving a resource allocation. For example, the resource control circuitry 1443 may receive an RRC message on a PDSCH that includes an indication of a resource allocation for transmission of feedback.

FIG. 15 is a flow chart illustrating an example method 1500 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1500 may be carried out by the user equipment 1400 illustrated in FIG. 14. In some examples, the method 1500 may be carried out by any suitable apparatus or means for carrying out the functions or algorithm described below.

At block 1502, a user equipment may receive data on a first component carrier of a plurality of component carriers, the plurality of component carriers being associated with an uplink control channel group. In some examples, the communication and processing circuitry 1441 and the transceiver 1410, shown and described in FIG. 14, may provide a means to receive data on a first component carrier of a plurality of component carriers.

At block 1504, the user equipment may receive a first indication that the user equipment is allowed to transmit feedback for the data on a second component carrier of the plurality of component carriers. In some examples, the feedback processing circuitry 1442 together with the communication and processing circuitry 1441 and the transceiver 1410, shown and described in FIG. 14, may provide a means to receive a first indication that the user equipment is allowed to transmit feedback for the data on a second component carrier of the plurality of component carriers.

In some examples, to receive the first indication, the user equipment may receive a radio resource control (RRC) message that includes the first indication on a per component carrier basis.

In some examples, the user equipment may transmit the feedback on a physical uplink control channel (PUCCH) of the second component carrier after receiving the first indication.

In some examples, the user equipment may receive the data on a physical downlink shared channel (PDSCH) of the first component carrier.

In some examples, the user equipment may receive a second indication that the user equipment is allowed to transmit the feedback for the data on a third component carrier of the plurality of component carriers, and select between the second component carrier and the third component carrier for transmitting the feedback. In some examples, the first component carrier is a primary component carrier, the second component carrier is a first secondary component carrier, and the third component carrier is a second secondary component carrier.

In some examples, the uplink control channel group may be a physical uplink control channel (PUCCH) group for uplink carrier aggregation.

In some examples, the user equipment may receive a first resource allocation, wherein the first resource allocation is for transmission of the feedback for the data on the first component carrier. In some examples, the user equipment may receive a second resource allocation, wherein the second resource allocation is for transmission of the feedback for the data on the second component carrier of the plurality of component carriers.

In some examples, the first component carrier is a primary component carrier, and the second component carrier is a secondary component carrier. In some examples, the first component carrier is a secondary component carrier, and the second component carrier is a primary component carrier.

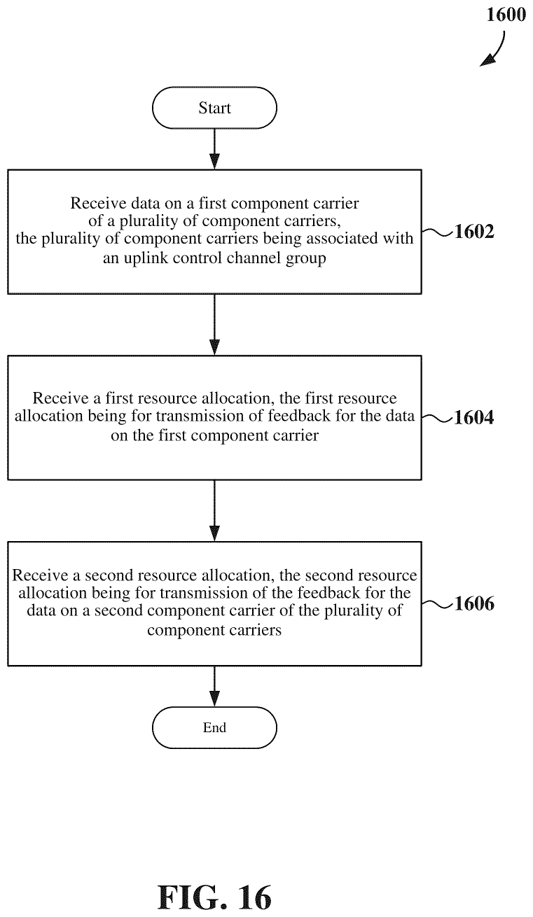

FIG. 16 is a flow chart illustrating an example method 1600 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1600 may be carried out by the user equipment 1400 illustrated in FIG. 14. In some examples, the method 1600 may be carried out by any suitable apparatus or means for carrying out the functions or algorithm described below.

At block 1602, a user equipment may receive data on a first component carrier of a plurality of component carriers, the plurality of component carriers being associated with an uplink control channel group. In some examples, the communication and processing circuitry 1441 and the transceiver 1410, shown and described in FIG. 14, may provide a means to receive data on a first component carrier of a plurality of component carriers.

At block 1604, the user equipment may receive a first resource allocation, the first resource allocation being for transmission of feedback for the data on the first component carrier. In some examples, the resource control circuitry 1443 together with the communication and processing circuitry 1441 and the transceiver 1410, shown and described in FIG. 14, may provide a means to receive a first resource allocation.

At block 1606, the user equipment may receive a second resource allocation, the second resource allocation being for transmission of the feedback for the data on a second component carrier of the plurality of component carriers. In some examples, the resource control circuitry 1443 together with the communication and processing circuitry 1441 and the transceiver 1410, shown and described in FIG. 14, may provide a means to receive a second resource allocation.

In some examples, the first resource allocation specifies a first set of physical uplink control channel (PUCCH) resources for the first component carrier, and the second resource allocation specifies a second set of PUCCH resources for the second component carrier.

In some examples, to receive the first resource allocation and the receive the second resource allocation, the user equipment may receive at least one radio resource control (RRC) configuration message that indicates the first resource allocation and the second resource allocation.

In some examples, the user equipment may receive a third resource allocation, wherein the third resource allocation is for transmission of the feedback for the data on a third component carrier of the plurality of component carriers. In some examples, the first component carrier is a primary component carrier, the second component carrier is a first secondary component carrier, and the third component carrier is a second secondary component carrier. In some examples, the user equipment may transmit the feedback on the second component carrier or the third component carrier.

In some examples, the first component carrier is assigned a first bandwidth, and the second component carrier is assigned a second bandwidth that is different from the first bandwidth.

In some examples, the user equipment may receive a first indication that the user equipment is allowed to transmit the feedback for the data on the second component carrier of the plurality of component carriers.

In some examples, the first component carrier is a primary component carrier, and the second component carrier is a secondary component carrier. In some examples, the first component carrier is a secondary component carrier, and the second component carrier is a primary component carrier.

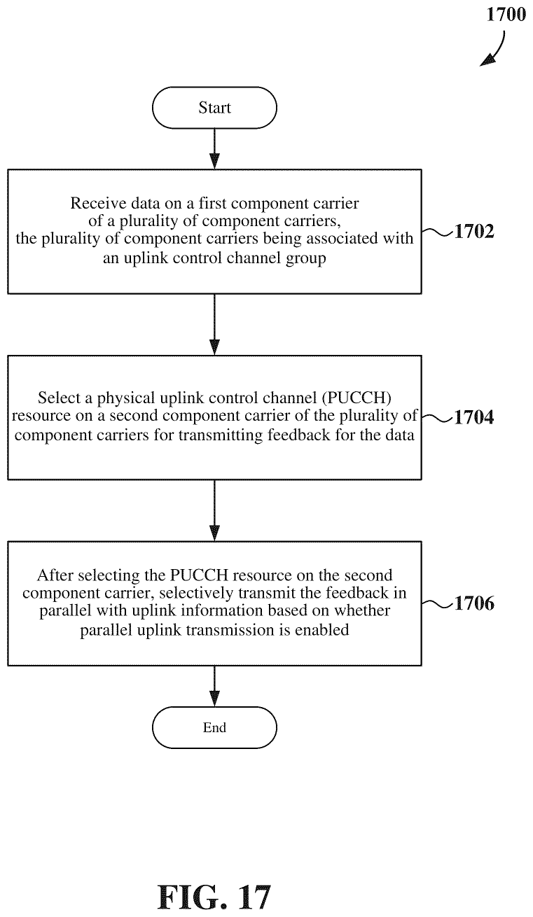

FIG. 17 is a flow chart illustrating an example method 1700 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1700 may be carried out by the user equipment 1400 illustrated in FIG. 14. In some examples, the method 1700 may be carried out by any suitable apparatus or means for carrying out the functions or algorithm described below.

At block 1702, a user equipment may receive data on a first component carrier of a plurality of component carriers, the plurality of component carriers being associated with an uplink control channel group. In some examples, the communication and processing circuitry 1441 and the transceiver 1410, shown and described in FIG. 14, may provide a means to receive data on a first component carrier of a plurality of component carriers.

At block 1704, the user equipment may select a physical uplink control channel (PUCCH) resource on a second component carrier of the plurality of component carriers for transmitting feedback for the data. In some examples, the resource control circuitry 1443, shown and described in FIG. 14, may provide a means to select a physical uplink control channel (PUCCH) resource on a second component carrier of the plurality of component carriers for transmitting feedback for the data.

At block 1706, the user equipment may, after selecting the PUCCH resource on the second component carrier, selectively transmit the feedback in parallel with uplink information based on whether parallel uplink transmission is enabled. In some examples, the feedback processing circuitry 1442 together with the communication and processing circuitry 1441 and the transceiver 1410, shown and described in FIG. 14, may provide a means to selectively transmit the feedback in parallel with uplink information based on whether parallel uplink transmission is enabled.

In some examples, to selectively transmit the feedback in parallel with the uplink information based on whether parallel uplink transmission is enabled, the user equipment may transmit the feedback in parallel with physical uplink shared channel (PUSCH) information when parallel uplink transmission is enabled.

In some examples, to selectively transmit the feedback in parallel with the uplink information based on whether parallel uplink transmission is enabled, the user equipment may multiplex the feedback with a physical uplink shared channel (PUSCH) when parallel uplink transmission is not enabled.

In some examples, to selectively transmit the feedback in parallel with the uplink information based on whether parallel uplink transmission is enabled, the user equipment may abstain from transmitting the feedback in parallel with the uplink information when parallel uplink transmission is not enabled.

In some examples, to selectively transmit the feedback in parallel with the uplink information based on whether parallel uplink transmission is enabled, the user equipment may abstain from transmitting the feedback in parallel with the uplink information after determining that the PUCCH resource does not overlap with a scheduled physical uplink shared channel (PUSCH) resource on the second component carrier or a scheduled uplink control information (UCI) resource on the second component carrier.

In some examples, the user equipment may transmit the feedback in parallel with physical uplink shared channel (PUSCH) information when parallel uplink transmission is enabled. In some examples, the user equipment may multiplex the feedback with a physical uplink shared channel (PUSCH) when parallel uplink transmission is not enabled.

In some examples, the first component carrier is a primary component carrier, and the second component carrier is a secondary component carrier. In some examples, the first component carrier is a secondary component carrier, and the second component carrier is a primary component carrier.

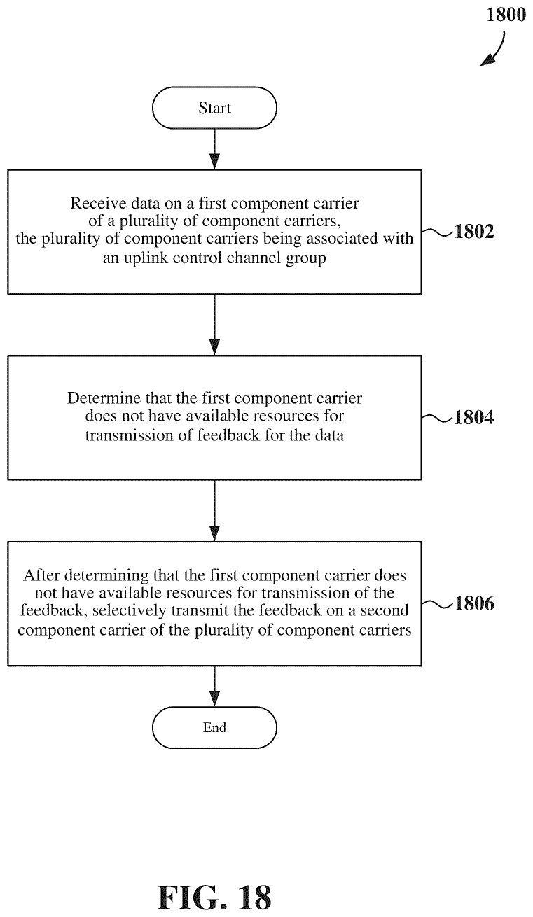

FIG. 18 is a flow chart illustrating an example method 1800 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1800 may be carried out by the user equipment 1400 illustrated in FIG. 14. In some examples, the method 1800 may be carried out by any suitable apparatus or means for carrying out the functions or algorithm described below.

At block 1802, a user equipment may receive data on a first component carrier of a plurality of component carriers, the plurality of component carriers being associated with an uplink control channel group. In some examples, the communication and processing circuitry 1441 and the transceiver 1410, shown and described in FIG. 14, may provide a means to receive data on a first component carrier of a plurality of component carriers.

At block 1804, the user equipment may determine that the first component carrier does not have available resources for transmission of feedback for the data. In some examples, the resource control circuitry 1443 together with the communication and processing circuitry 1441 and the transceiver 1410, shown and described in FIG. 14, may provide a means to determine that the first component carrier does not have available resources for transmission of feedback for the data.

At block 1806, the user equipment may, after determining that the first component carrier does not have available resources for transmission of the feedback, selectively transmit the feedback on a second component carrier of the plurality of component carriers. In some examples, the feedback processing circuitry 1442 together with the communication and processing circuitry 1441 and the transceiver 1410, shown and described in FIG. 14, may provide a means to selectively transmit the feedback on a second component carrier of the plurality of component carriers.

In some examples, the user equipment may receive an indication that only one secondary component carrier of the plurality of component carriers can be used to transmit the feedback.

In some examples, to determine that the first component carrier does not have available resources for transmission of the feedback, the user equipment may identify a slot on the first component carrier for transmission of the feedback, and identify that transmission of the feedback conflicts with at least one downlink orthogonal frequency division multiplexing (ODFM) symbol.

In some examples, to selectively transmit the feedback on a second component carrier of the plurality of component carriers, the user equipment may transmit the feedback on a physical uplink control channel (PUCCH) resource on the second component carrier when the second component carrier has available resources for transmission of the feedback.

In some examples, to selectively transmit the feedback on a second component carrier of the plurality of component carriers, the user equipment may abstain from transmitting the feedback on a physical uplink control channel (PUCCH) resource on the second component carrier when the second component carrier does not have available resources for transmission of the feedback.

In some examples, the first component carrier is a primary component carrier, and the second component carrier is a secondary component carrier. In some examples, the first component carrier is a secondary component carrier, and the second component carrier is a primary component carrier.

In one configuration, the user equipment 1400 includes means for receiving data on a first component carrier of a plurality of component carriers, the plurality of component carriers being associated with an uplink control channel group, and means for receiving a first indication that the user equipment is allowed to transmit feedback for the data on a second component carrier of the plurality of component carriers. In one configuration, the user equipment 1400 includes means for receiving data on a first component carrier of a plurality of component carriers, the plurality of component carriers being associated with an uplink control channel group, means for receiving a first resource allocation, the first resource allocation being for transmission of feedback for the data on the first component carrier, and means for receiving a second resource allocation, the second resource allocation being for transmission of the feedback for the data on a second component carrier of the plurality of component carriers. In one configuration, the user equipment 1400 includes means for receiving data on a first component carrier of a plurality of component carriers, the plurality of component carriers being associated with an uplink control channel group, means for selecting a physical uplink control channel (PUCCH) resource on a second component carrier of the plurality of component carriers for transmitting feedback for the data, and means for, after the selecting the PUCCH resource on the second component carrier, selectively transmitting the feedback in parallel with uplink information based on whether parallel uplink transmission is enabled. In one configuration, the user equipment 1400 includes means for receiving data on a first component carrier of a plurality of component carriers, the plurality of component carriers being associated with an uplink control channel group, means for determining that the first component carrier does not have available resources for transmission of feedback for the data, and means for, after the determining that the first component carrier does not have available resources for transmission of the feedback, selectively transmitting the feedback on a second component carrier of the plurality of component carriers. In one aspect, the aforementioned means may be the processor 1404 shown in FIG. 14 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable medium 1406, or any other suitable apparatus or means described in any one or more of FIGS. 1, 2, 4, 5, 6, 13, and 14, and utilizing, for example, the methods and/or algorithms described herein in relation to FIGS. 15-18.

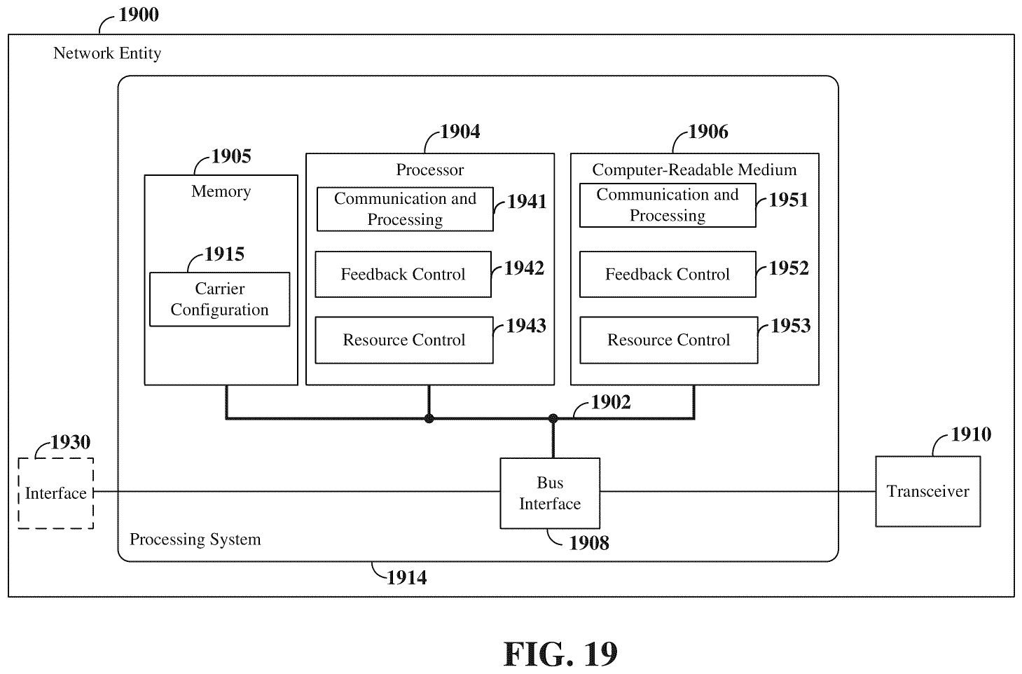

FIG. 19 is a conceptual diagram illustrating an example of a hardware implementation for network entity 1900 employing a processing system 1914. In some implementations, the network entity 1900 may correspond to any of the network entities, BSs (e.g., gNBs), CUs, DU, RUs, or scheduling entities shown in any of FIGS. 1, 2, 4, 5, 6, and 13.

In accordance with various aspects of the disclosure, an element, or any portion of an element, or any combination of elements may be implemented with the processing system 1914. The processing system may include one or more processors 1904. The processing system 1914 may be substantially the same as the processing system 1414 illustrated in FIG. 14, including a bus interface 1908, a bus 1902, memory 1905, a processor 1904, and a computer-readable medium 1906. The memory 1905 may store carrier configuration information 1915 (e.g., PCC and SCC information) used by the processor 1904 for communication operations as discussed herein. Furthermore, the network entity 1900 may include an interface 1930 (e.g., a network interface) that provides a means for communicating with at least one other apparatus within a core network and with at least one radio access network.

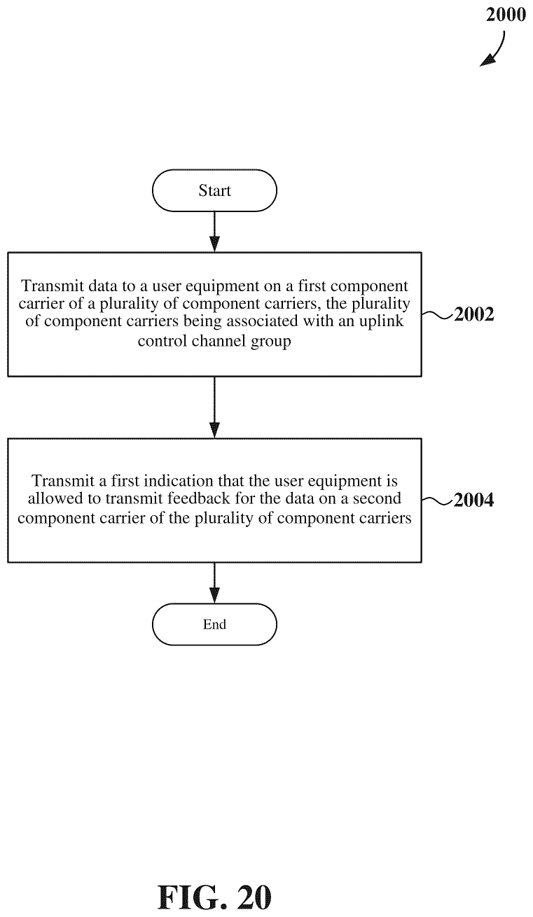

The network entity 1900 may be configured to perform any one or more of the operations described herein (e.g., as described above in conjunction with FIGS. 1-13 and as described below in conjunction with FIGS. 20-23). In some aspects of the disclosure, the processor 1904, as utilized in the network entity 1900, may include circuitry configured for various functions.

The processor 1904 may be configured to generate, schedule, and modify a resource assignment or grant of time-frequency resources (e.g., a set of one or more resource elements). For example, the processor 1904 may schedule time-frequency resources within a plurality of time division duplex (TDD) and/or frequency division duplex (FDD) subframes, slots, and/or mini-slots to carry user data traffic and/or control information to and/or from multiple UEs. The processor 1904 may be configured to schedule resources for the transmission of downlink signals and/or resources for the transmission of uplink signals.

In some aspects of the disclosure, the processor 1904 may include communication and processing circuitry 1941. The communication and processing circuitry 1944 may be configured to communicate with a UE. The communication and processing circuitry 1941 may include one or more hardware components that provide the physical structure that performs various processes related to communication (e.g., signal reception and/or signal transmission) as described herein. The communication and processing circuitry 1941 may further include one or more hardware components that provide the physical structure that performs various processes related to signal processing (e.g., processing a received signal and/or processing a signal for transmission) as described herein. The communication and processing circuitry 1941 may further be configured to execute communication and processing software 1951 included on the computer-readable medium 1906 to implement one or more functions described herein.

The communication and processing circuitry 1941 may further be configured to transmit a message to a UE and/or receive a message from a UE. For example, a downlink message be included in a MAC-CE carried in a PDSCH, a DCI carried in a PDCCH or PDSCH, or an RRC message. In addition, an uplink message be included in a MAC-CE carried in a PUSCH, UCI carried in a PUCCH, a random access message, or an RRC message.

In some implementations wherein the communication involves receiving information, the communication and processing circuitry 1941 may obtain information from a component of the network entity 1900 (e.g., from the transceiver 1910 that receives the information via radio frequency signaling or some other type of signaling suitable for the applicable communication medium), process (e.g., decode) the information, and output the processed information. For example, the communication and processing circuitry 1941 may output the information to another component of the processor 1904, to the memory 1905, or to the bus interface 1908. In some examples, the communication and processing circuitry 1941 may receive one or more of signals, messages, other information, or any combination thereof. In some examples, the communication and processing circuitry 1941 may receive information via one or more channels. In some examples, the communication and processing circuitry 1941 may include functionality for a means for receiving. In some examples, the communication and processing circuitry 1941 may include functionality for a means for decoding. In some examples, the communication and processing circuitry 1941 may include functionality for a means for receiving feedback data on one or more component carriers.

In some implementations wherein the communication involves sending (e.g., transmitting) information, the communication and processing circuitry 1941 may obtain information (e.g., from another component of the processor 1904, the memory 1905, or the bus interface 1908), process (e.g., encode) the information, and output the processed information. For example, the communication and processing circuitry 1941 may output the information to the transceiver 1910 (e.g., that transmits the information via radio frequency signaling or some other type of signaling suitable for the applicable communication medium). In some examples, the communication and processing circuitry 1941 may send one or more of signals, messages, other information, or any combination thereof. In some examples, the communication and processing circuitry 1941 may send information via one or more channels. In some examples, the communication and processing circuitry 1941 may include functionality for a means for sending (e.g., a means for transmitting). In some examples, the communication and processing circuitry 1941 may include functionality for a means for encoding. In some examples, the communication and processing circuitry 1941 may include functionality for a means for transmitting data on one or more component carriers.

The processor 1904 may include feedback control circuitry 1942 configured to perform feedback control-related operations as discussed herein (e.g., one or more of the operations described above in conjunction with FIGS. 8-13). The feedback control circuitry 1942 may be configured to execute feedback control software 1952 included on the computer-readable medium 1906 to implement one or more functions described herein.

The feedback control circuitry 1942 may include functionality for a means for transmitting an indication that a UE is allowed to transmit feedback on another CC (e.g., as described above in conjunction with FIGS. 8-13). For example, the feedback control circuitry 1942 together with the communication and processing circuitry 1941 and the transceiver 1910 may transmit an RRC message on a PDSCH that includes the indication.

The processor 1904 may include resource control circuitry 1943 configured to perform resource control-related operations as discussed herein (e.g., one or more of the operations described above in conjunction with FIGS. 8-13). The resource control circuitry 1943 may be configured to execute resource control software 1953 included on the computer-readable medium 1906 to implement one or more functions described herein.

The resource control circuitry 1943 may include functionality for a means for identifying a resource. For example, the resource control circuitry 1943 may select one CC of a set of CCs for PUCCH transmissions.

The resource control circuitry 1943 may include functionality for a means for transmitting a resource allocation. For example, the resource control circuitry 1943 may transmit an RRC message on a PDSCH that includes an indication of a resource allocation for transmission of feedback.

In some examples, the network entity 1900 shown and described above in connection with FIG. 19 may be a disaggregated base station. For example, the network entity 1900 shown in FIG. 19 may include the CU and optionally one or more DUs/RUs of the disaggregated base station. Other DUs/RUs associated with the network entity 1900 may be distributed throughout the network. In some examples, the DUs/RUs may correspond to TRPs associated with the network entity. In some examples, the CU and/or DU/RU of the disaggregated base station (e.g., within the network entity 1900) may generate data and provide the data to a user equipment via a first component carrier of a plurality of component carriers, wherein the plurality of component carriers is associated with an uplink control channel group.

FIG. 20 is a flow chart illustrating another example method 2000 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2000 may be carried out by the network entity 1900 illustrated in FIG. 19. In some examples, the method 2000 may be carried out by any suitable apparatus or means for carrying out the functions or algorithm described below.

At block 2002, a network entity may transmit data to a user equipment on a first component carrier of a plurality of component carriers, the plurality of component carriers being associated with an uplink control channel group. In some examples, the communication and processing circuitry 1941 and the transceiver 1910, shown and described in FIG. 19, may provide a means to transmit data to a user equipment on a first component carrier of a plurality of component carriers.

At block 2004, the network entity may transmit a first indication that the user equipment is allowed to transmit feedback for the data on a second component carrier of the plurality of component carriers. In some examples, the feedback control circuitry 1942 together with the communication and processing circuitry 1941 and the transceiver 1910, shown and described in FIG. 19, may provide a means to transmit a first indication that the user equipment is allowed to transmit feedback for the data on a second component carrier of the plurality of component carriers.

In some examples, the network entity may transmit a radio resource control (RRC) message that includes the first indication.

In some examples, the network entity may receive the feedback on a physical uplink control channel (PUCCH) of the second component carrier after the transmitting the first indication.

In some examples, the network entity may transmit the data on a physical downlink shared channel (PDSCH) of the first component carrier.

In some examples, the network entity may transmit a second indication that the user equipment is allowed to transmit the feedback for the data on a third component carrier of the plurality of component carriers, and receive the feedback on the second component carrier or the third component carrier. In some examples, the first component carrier is a primary component carrier, the second component carrier is a first secondary component carrier, and the third component carrier is a second secondary component carrier.

In some examples, the uplink control channel group may be a physical uplink control channel (PUCCH) group for uplink carrier aggregation.

In some examples, the network entity may transmit a first resource allocation, wherein the first resource allocation is for transmission of the feedback for the data on the first component carrier. In some examples, the network entity may transmit a second resource allocation, wherein the second resource allocation is for transmission of the feedback for the data on the second component carrier of the plurality of component carriers.

In some examples, the first component carrier is a primary component carrier, and the second component carrier is a secondary component carrier. In some examples, the first component carrier is a secondary component carrier, and the second component carrier is a primary component carrier.

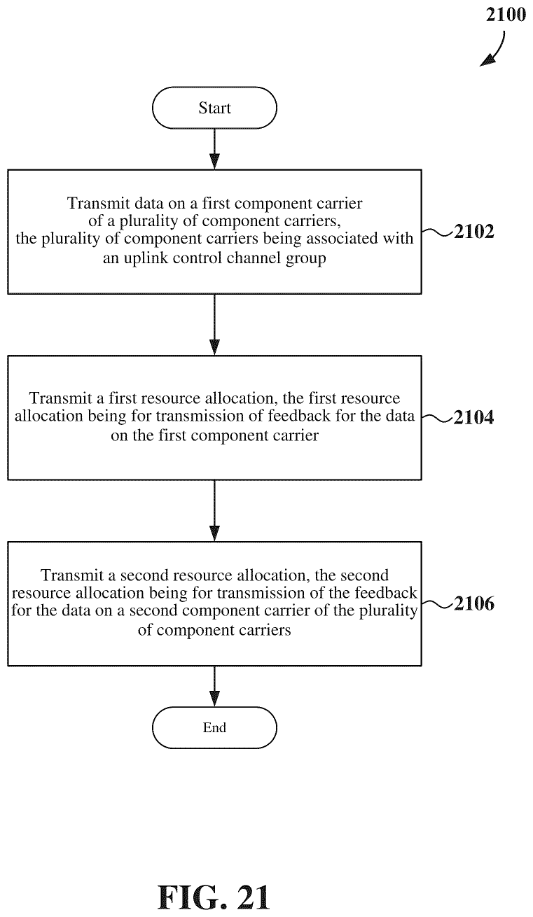

FIG. 21 is a flow chart illustrating another example method 2100 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2100 may be carried out by the network entity 1900 illustrated in FIG. 19. In some examples, the method 2100 may be carried out by any suitable apparatus or means for carrying out the functions or algorithm described below.

At block 2102, a network entity may transmit data on a first component carrier of a plurality of component carriers, the plurality of component carriers being associated with an uplink control channel group. In some examples, the communication and processing circuitry 1941 and the transceiver 1910, shown and described in FIG. 19, may provide a means to transmit data on a first component carrier of a plurality of component carriers.

At block 2104, the network entity may transmit a first resource allocation, the first resource allocation being for transmission of feedback for the data on the first component carrier. In some examples, the resource control circuitry 1943 together with the communication and processing circuitry 1941 and the transceiver 1910, shown and described in FIG. 19, may provide a means to transmit a first resource allocation.

At block 2106, the network entity may transmit a second resource allocation, the second resource allocation being for transmission of the feedback for the data on a second component carrier of the plurality of component carriers. In some examples, the resource control circuitry 1943 together with the communication and processing circuitry 1941 and the transceiver 1910, shown and described in FIG. 19, may provide a means to transmit a second resource allocation.

In some examples, the first resource allocation specifies a first set of physical uplink control channel (PUCCH) resources for the first component carrier, and the second resource allocation specifies a second set of PUCCH resources for the second component carrier.

In some examples, the network entity may transmit at least one radio resource control (RRC) configuration message that indicates the first resource allocation and the second resource allocation.

In some examples, the network entity may transmit a third resource allocation, wherein the third resource allocation is for transmission of the feedback for the data on a third component carrier of the plurality of component carriers. In some examples, the first component carrier is a primary component carrier, the second component carrier is a first secondary component carrier, and the third component carrier is a second secondary component carrier.

In some examples, the network entity may receive the feedback on the second component carrier or the third component carrier.

In some examples, the first component carrier is assigned a first bandwidth, and the second component carrier is assigned a second bandwidth that is different from the first bandwidth.

In some examples, the network entity may transmit a first indication that a user equipment is allowed to transmit the feedback for the data on the second component carrier of the plurality of component carriers.

In some examples, the first component carrier is a primary component carrier, and the second component carrier is a secondary component carrier. In some examples, the first component carrier is a secondary component carrier, and the second component carrier is a primary component carrier.

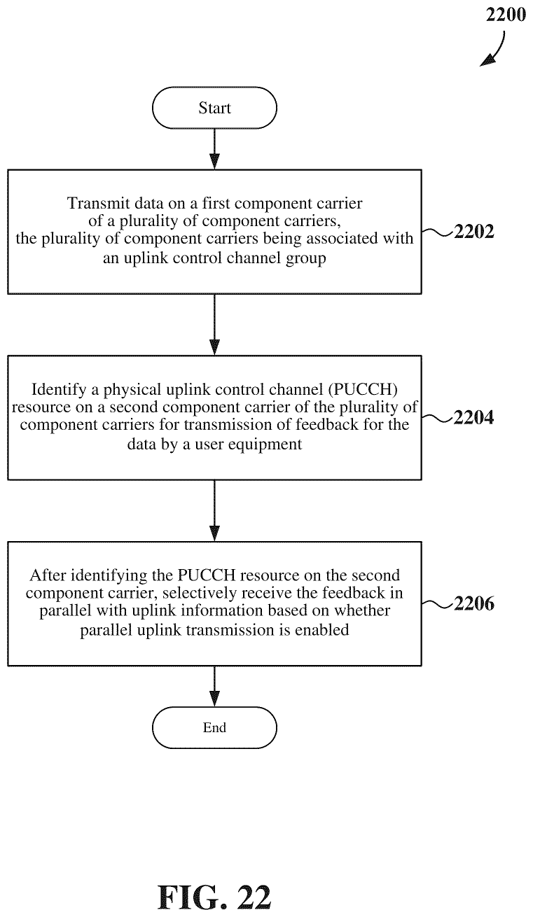

FIG. 22 is a flow chart illustrating another example method 2200 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2200 may be carried out by the network entity 1900 illustrated in FIG. 19. In some examples, the method 2200 may be carried out by any suitable apparatus or means for carrying out the functions or algorithm described below.

At block 2202, a network entity may transmit data on a first component carrier of a plurality of component carriers, the plurality of component carriers being associated with an uplink control channel group. In some examples, the communication and processing circuitry 1941 and the transceiver 1910, shown and described in FIG. 19, may provide a means to transmit data on a first component carrier of a plurality of component carriers.

At block 2204, the network entity may identify a physical uplink control channel (PUCCH) resource on a second component carrier of the plurality of component carriers for transmission of feedback for the data by a user equipment. In some examples, the resource control circuitry 1943, shown and described in FIG. 19, may provide a means to identify a physical uplink control channel (PUCCH) resource on a second component carrier of the plurality of component carriers for transmission of feedback for the data by a user equipment.

At block 2206, the network entity may, after identifying the PUCCH resource on the second component carrier, selectively receive the feedback in parallel with uplink information based on whether parallel uplink transmission is enabled. In some examples, the feedback control circuitry 1942 together with the communication and processing circuitry 1941 and the transceiver 1910, shown and described in FIG. 19, may provide a means to selectively receive the feedback in parallel with uplink information based on whether parallel uplink transmission is enabled.

In some examples, to selectively receive the feedback in parallel with the uplink information based on whether parallel uplink transmission is enabled, the network entity may receive the feedback in parallel with physical uplink shared channel (PUSCH) information when parallel uplink transmission is enabled.

In some examples, to selectively receive the feedback in parallel with the uplink information based on whether parallel uplink transmission is enabled, the network entity may receive multiplexed feedback and uplink control information (UCI) when parallel uplink transmission is enabled.

In some examples, to selectively receive the feedback in parallel with the uplink information based on whether parallel uplink transmission is enabled, the network entity may abstain from receiving the feedback in parallel with the uplink information when parallel uplink transmission is not enabled.

In some examples, the first component carrier is a primary component carrier, and the second component carrier is a secondary component carrier. In some examples, the first component carrier is a secondary component carrier, and the second component carrier is a primary component carrier.

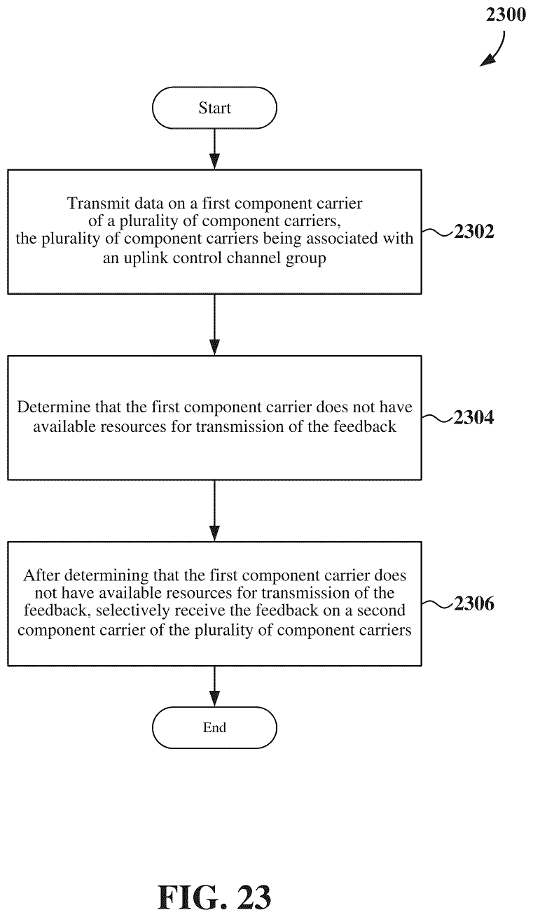

FIG. 23 is a flow chart illustrating another example method 2300 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 2300 may be carried out by the network entity 1900 illustrated in FIG. 19. In some examples, the method 2300 may be carried out by any suitable apparatus or means for carrying out the functions or algorithm described below.

At block 2302, a network entity may transmit data on a first component carrier of a plurality of component carriers, the plurality of component carriers being associated with an uplink control channel group. In some examples, the communication and processing circuitry 1941 and the transceiver 1910, shown and described in FIG. 19, may provide a means to transmit data on a first component carrier of a plurality of component carriers.

At block 2304, the network entity may determine that the first component carrier does not have available resources for transmission of feedback for the data. In some examples, the resource control circuitry 1943 together with the communication and processing circuitry 1941 and the transceiver 1910, shown and described in FIG. 19, may provide a means to determine that the first component carrier does not have available resources for transmission of feedback for the data.

At block 2306, the network entity may, after determining that the first component carrier does not have available resources for transmission of the feedback, selectively receive the feedback on a second component carrier of the plurality of component carriers. In some examples, the feedback control circuitry 1942 together with the communication and processing circuitry 1941 and the transceiver 1910, shown and described in FIG. 19, may provide a means to selectively receive the feedback on a second component carrier of the plurality of component carriers.

In some examples, the network entity may transmit an indication that only one secondary component carrier of the plurality of component carriers can be used to transmit the feedback.

In some examples, to determine that the first component carrier does not have available resources for transmission of the feedback, the network entity may identify a slot on the first component carrier for transmission of the feedback, and identify a scheduled downlink transmission during the slot that conflicts with the transmission of the feedback.

In some examples, to selectively receive the feedback on a second component carrier of the plurality of component carriers, the network entity may receive the feedback on a physical uplink control channel (PUCCH) resource on the second component carrier when the second component carrier has available resources for transmission of the feedback.

In some examples, to selectively receive the feedback on a second component carrier of the plurality of component carriers, the network entity may abstain from receiving the feedback on a physical uplink control channel (PUCCH) resource on the second component carrier when the second component carrier does not have available resources for transmission of the feedback.

In some examples, the first component carrier is a primary component carrier, and the second component carrier is a secondary component carrier. In some examples, the first component carrier is a secondary component carrier, and the second component carrier is a primary component carrier.

In one configuration, the network entity 1900 includes means for transmitting data to a user equipment on a first component carrier of a plurality of component carriers, the plurality of component carriers being associated with an uplink control channel group, and means for transmitting a first indication that the user equipment is allowed to transmit feedback for the data on a second component carrier of the plurality of component carriers. In one configuration, the network entity 1900 includes means for transmitting data on a first component carrier of a plurality of component carriers, means for transmitting a first resource allocation, the first resource allocation being for transmission of feedback for the data on the first component carrier, and means for transmitting a second resource allocation, the second resource allocation being for transmission of the feedback for the data on a second component carrier of the plurality of component carriers. In one configuration, the network entity 1900 includes means for transmitting data on a first component carrier of a plurality of component carriers, the plurality of component carriers being associated with an uplink control channel group, means for identifying a physical uplink control channel (PUCCH) resource on a second component carrier of the plurality of component carriers for transmission of feedback for the data by a user equipment, and means for, after the identifying the PUCCH resource on the second component carrier, selectively receiving the feedback in parallel with uplink information based on whether parallel uplink transmission is enabled. In one configuration, the network entity 1900 includes means for transmitting data on a first component carrier of a plurality of component carriers, the plurality of component carriers being associated with an uplink control channel group, means for determining that the first component carrier does not have available resources for transmission of feedback for the data, and means for, after the determining that the first component carrier does not have available resources for transmission of the feedback, selectively receiving the feedback on a second component carrier of the plurality of component carriers. In one aspect, the aforementioned means may be the processor 1904 shown in FIG. 19 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1904 is merely provided as an example, and other means for carrying out the described functions may be included within various aspects of the present disclosure, including but not limited to the instructions stored in the computer-readable medium 1906, or any other suitable apparatus or means described in any one or more of FIGS. 1, 2, 4, 5, 6, 13, and 19, and utilizing, for example, the methods and/or algorithms described herein in relation to FIGS. 20-23.

The methods shown in FIGS. 15-18 and 20-23 may include additional aspects, such as any single aspect or any combination of aspects described below and/or in connection with one or more other processes described elsewhere herein.

In some examples, a user equipment may include a transceiver, a memory, and a processor coupled to the transceiver and the memory. The processor and the memory may be configured to receive data on a first component carrier of a plurality of component carriers, the plurality of component carriers being associated with an uplink control channel group, determine that the first component carrier does not have available resources for transmission of feedback for the data, and after the determination that the first component carrier does not have available resources for transmission of the feedback, selectively transmit the feedback on a second component carrier of the plurality of component carriers.

In some examples, a method for wireless communication at a user equipment is disclosed. The method may include receiving data on a first component carrier of a plurality of component carriers, the plurality of component carriers being associated with an uplink control channel group, determining that the first component carrier does not have available resources for transmission of feedback for the data, and after the determining that the first component carrier does not have available resources for transmission of the feedback, selectively transmitting the feedback on a second component carrier of the plurality of component carriers.

In some examples, a user equipment may include means for receiving data on a first component carrier of a plurality of component carriers, the plurality of component carriers being associated with an uplink control channel group, means for determining that the first component carrier does not have available resources for transmission of feedback for the data, and means for, after the determining that the first component carrier does not have available resources for transmission of the feedback, selectively transmitting the feedback on a second component carrier of the plurality of component carriers.

In some examples, an article of manufacture for use by a user equipment includes a non-transitory computer-readable medium having stored therein instructions executable by one or more processors of the user equipment to receive data on a first component carrier of a plurality of component carriers, the plurality of component carriers being associated with an uplink control channel group, determine that the first component carrier does not have available resources for transmission of feedback for the data, and after the determination that the first component carrier does not have available resources for transmission of the feedback, selectively transmit the feedback on a second component carrier of the plurality of component carriers.

In some examples, a network entity may include a transceiver, a memory, and a processor coupled to the transceiver and the memory. The processor and the memory may be configured to transmit data on a first component carrier of a plurality of component carriers, the plurality of component carriers being associated with an uplink control channel group, determine that the first component carrier does not have available resources for transmission of feedback for the data, and after the determination that the first component carrier does not have available resources for transmission of the feedback, selectively receive the feedback on a second component carrier of the plurality of component carriers.

In some examples, a method for wireless communication at a network entity is disclosed. The method may include transmitting data on a first component carrier of a plurality of component carriers, the plurality of component carriers being associated with an uplink control channel group, determining that the first component carrier does not have available resources for transmission of feedback for the data, and after the determining that the first component carrier does not have available resources for transmission of the feedback, selectively receiving the feedback on a second component carrier of the plurality of component carriers.

In some examples, a network entity may include means for transmitting data on a first component carrier of a plurality of component carriers, the plurality of component carriers being associated with an uplink control channel group, means for determining that the first component carrier does not have available resources for transmission of feedback for the data, and means for, after the determining that the first component carrier does not have available resources for transmission of the feedback, selectively receiving the feedback on a second component carrier of the plurality of component carriers.

In some examples, an article of manufacture for use by a network entity includes a non-transitory computer-readable medium having stored therein instructions executable by one or more processors of the network entity to transmit data on a first component carrier of a plurality of component carriers, the plurality of component carriers being associated with an uplink control channel group, determine that the first component carrier does not have available resources for transmission of feedback for the data, and after the determination that the first component carrier does not have available resources for transmission of the feedback, selectively receive the feedback on a second component carrier of the plurality of component carriers.

The following provides an overview of several aspects of the present disclosure.

Aspect 1: A method for wireless communication at a user equipment, the method comprising: receiving data on a first component carrier of a plurality of component carriers, the plurality of component carriers being associated with an uplink control channel group; and receiving a first indication that the user equipment is allowed to transmit feedback for the data on a second component carrier of the plurality of component carriers.

Aspect 2: The method of aspect 1, wherein the receiving the first indication comprises: receiving a radio resource control (RRC) message that includes the first indication on a per component carrier basis.

Aspect 3: The method of aspect 1 or 2, further comprising: transmitting the feedback on a physical uplink control channel (PUCCH) of the second component carrier after the receiving the first indication.

Aspect 4: The method of aspect 3, wherein the receiving the data comprises: receiving the data on a physical downlink shared channel (PDSCH) of the first component carrier.

Aspect 5: The method of any of aspects 1 through 4, further comprising: receiving a second indication that the user equipment is allowed to transmit the feedback for the data on a third component carrier of the plurality of component carriers; and selecting between the second component carrier and the third component carrier for transmitting the feedback.

Aspect 6: The method of aspect 5, wherein: the first component carrier is a primary component carrier; the second component carrier is a first secondary component carrier; and the third component carrier is a second secondary component carrier.

Aspect 7: The method of any of aspects 1 through 6, wherein the uplink control channel group comprises a physical uplink control channel (PUCCH) group for uplink carrier aggregation.

Aspect 8: The method of any of aspects 1 through 5 and 7, wherein: the second component carrier is a primary component carrier; and the first component carrier is a secondary component carrier.

Aspect 9: The method of any of aspects 1 through 8, further comprising: receiving a first resource allocation, wherein the first resource allocation is for transmission of the feedback for the data on the first component carrier; and receiving a second resource allocation, wherein the second resource allocation is for transmission of the feedback for the data on the second component carrier of the plurality of component carriers.

Aspect 11: A method for wireless communication at a network entity, the method comprising: transmitting data to a user equipment on a first component carrier of a plurality of component carriers, the plurality of component carriers being associated with an uplink control channel group; and transmitting a first indication that the user equipment is allowed to transmit feedback for the data on a second component carrier of the plurality of component carriers.

Aspect 12: The method of aspect 11, wherein the transmitting the first indication comprises: transmitting a radio resource control (RRC) message that includes the first indication.

Aspect 13: The method of any of aspects 11 through 12, further comprising: receiving the feedback on a physical uplink control channel (PUCCH) of the second component carrier after the transmitting the first indication.

Aspect 14: The method of aspect 13, wherein the transmitting the data comprises: transmitting the data on a physical downlink shared channel (PDSCH) of the first component carrier.

Aspect 15: The method of any of aspects 11 through 14, further comprising: transmitting a second indication that the user equipment is allowed to transmit the feedback for the data on a third component carrier of the plurality of component carriers; and receiving the feedback on the second component carrier or the third component carrier.

Aspect 16: The method of any of aspect 15, wherein: the first component carrier is a primary component carrier; the second component carrier is a first secondary component carrier; and the third component carrier is a second secondary component carrier.

Aspect 17: The method of any of aspects 11 through 16, wherein the uplink control channel group comprises a physical uplink control channel (PUCCH) group for uplink carrier aggregation.

Aspect 18: The method of any of aspects 11 through 14 and 17, wherein: the second component carrier is a primary component carrier; and the first component carrier is a secondary component carrier.

Aspect 19: The method of any of aspects 11 through 18 further comprising: transmitting a first resource allocation, wherein the first resource allocation is for transmission of the feedback for the data on the first component carrier; and transmitting a second resource allocation, wherein the second resource allocation is for transmission of the feedback for the data on the second component carrier of the plurality of component carriers.

Aspect 21: A method for wireless communication at a user equipment, the method comprising: receiving data on a first component carrier of a plurality of component carriers, the plurality of component carriers being associated with an uplink control channel group; receiving a first resource allocation, the first resource allocation being for transmission of feedback for the data on the first component carrier; and receiving a second resource allocation, the second resource allocation being for transmission of the feedback for the data on a second component carrier of the plurality of component carriers.

Aspect 22: The method of aspect 21, wherein: the first resource allocation specifies a first set of physical uplink control channel (PUCCH) resources for the first component carrier; and the second resource allocation specifies a second set of PUCCH resources for the second component carrier.

Aspect 23: The method of any of aspects 21 through 22, wherein the receiving the first resource allocation and the receiving the second resource allocation comprises: receiving at least one radio resource control (RRC) configuration message that indicates the first resource allocation and the second resource allocation.

Aspect 24: The method of any of aspects 21 through 23, further comprising: receiving a third resource allocation, wherein the third resource allocation is for transmission of the feedback for the data on a third component carrier of the plurality of component carriers.

Aspect 25: The method of aspect 24, wherein: the first component carrier is a primary component carrier; the second component carrier is a first secondary component carrier; and the third component carrier is a second secondary component carrier.

Aspect 26: The method of any of aspects 24 through 25, further comprising: transmitting the feedback on the second component carrier or the third component carrier.

Aspect 27: The method of any of aspects 21 through 26, wherein: the first component carrier is assigned a first bandwidth; and the second component carrier is assigned a second bandwidth that is different from the first bandwidth.

Aspect 28: The method of any of aspects 21 through 24 and 27, wherein: the second component carrier is a primary component carrier; and the first component carrier is a secondary component carrier.

Aspect 29: The method of any of aspects 21 through 28 further comprising: receiving a first indication that the user equipment is allowed to transmit the feedback for the data on the second component carrier of the plurality of component carriers.

Aspect 31: A method for wireless communication at a network entity, the method comprising: transmitting data on a first component carrier of a plurality of component carriers, the plurality of component carriers being associated with an uplink control channel group; transmitting a first resource allocation, the first resource allocation being for transmission of feedback for the data on the first component carrier; and transmitting a second resource allocation, the second resource allocation being for transmission of the feedback for the data on a second component carrier of the plurality of component carriers.

Aspect 32: The method of aspect 31, wherein: the first resource allocation specifies a first set of physical uplink control channel (PUCCH) resources for the first component carrier; and the second resource allocation specifies a second set of PUCCH resources for the second component carrier.

Aspect 33: The method of any of aspects 31 through 32, wherein the transmitting the first resource allocation and the transmitting the second resource allocation comprises: transmitting at least one radio resource control (RRC) configuration message that indicates the first resource allocation and the second resource allocation.

Aspect 34: The method of any of aspects 31 through 33, further comprising: transmitting a third resource allocation, wherein the third resource allocation is for transmission of the feedback for the data on a third component carrier of the plurality of component carriers.

Aspect 35: The method of aspect 34, wherein: the first component carrier is a primary component carrier; the second component carrier is a first secondary component carrier; and the third component carrier is a second secondary component carrier.

Aspect 36: The method of any of aspects 34 through 35, further comprising: receiving the feedback on the second component carrier or the third component carrier.

Aspect 37: The method of any of aspects 31 through 36, wherein: the first component carrier is assigned a first bandwidth; and the second component carrier is assigned a second bandwidth that is different from the first bandwidth.

Aspect 38: The method of any of aspects 31 through 34 and 37, wherein: the second component carrier is a primary component carrier; and the first component carrier is a secondary component carrier.

Aspect 39: The method of any of aspects 31 through 38 further comprising: receiving a first indication that the user equipment is allowed to transmit the feedback for the data on the second component carrier of the plurality of component carriers.

Aspect 41: A method for wireless communication at a user equipment, the method comprising: receiving data on a first component carrier of a plurality of component carriers, the plurality of component carriers being associated with an uplink control channel group; selecting a physical uplink control channel (PUCCH) resource on a second component carrier of the plurality of component carriers for transmitting feedback for the data; and after the selecting the PUCCH resource on the second component carrier, selectively transmitting the feedback in parallel with uplink information based on whether parallel uplink transmission is enabled.

Aspect 42: The method of aspect 41, wherein the selectively transmitting the feedback in parallel with the uplink information based on whether parallel uplink transmission is enabled comprises: transmitting the feedback in parallel with physical uplink shared channel (PUSCH) information when parallel uplink transmission is enabled.

Aspect 43: The method of aspect 41, wherein the selectively transmitting the feedback in parallel with the uplink information based on whether parallel uplink transmission is enabled comprises: multiplexing the feedback with a physical uplink shared channel (PUSCH) when parallel uplink transmission is not enabled.

Aspect 44: The method of aspect 41, wherein the selectively transmitting the feedback in parallel with the uplink information based on whether parallel uplink transmission is enabled comprises: abstaining from transmitting the feedback in parallel with the uplink information when parallel uplink transmission is not enabled.

Aspect 45: The method of aspect 41, wherein the selectively transmitting the feedback in parallel with the uplink information based on whether parallel uplink transmission is enabled comprises: abstaining from transmitting the feedback in parallel with the uplink information after determining that the PUCCH resource does not overlap with a scheduled physical uplink shared channel (PUSCH) resource on the second component carrier or a scheduled uplink control information (UCI) resource on the second component carrier.

Aspect 46: The method of any of aspects 41 through 45, wherein: the first component carrier is a primary component carrier; and the second component carrier is a secondary component carrier.

Aspect 47: The method of any of aspects 41 through 45, wherein: the second component carrier is a primary component carrier; and the first component carrier is a secondary component carrier.

Aspect 48: The method of any of aspects 41 and 46 through 47 further comprising: transmitting the feedback in parallel with physical uplink shared channel (PUSCH) information when parallel uplink transmission is enabled; and multiplexing the feedback with a physical uplink shared channel (PUSCH) when parallel uplink transmission is not enabled.

Aspect 51: A method for wireless communication at a network entity, the method comprising: transmitting data on a first component carrier of a plurality of component carriers, the plurality of component carriers being associated with an uplink control channel group; identifying a physical uplink control channel (PUCCH) resource on a second component carrier of the plurality of component carriers for transmission of feedback for the data by a user equipment; and after the identifying the PUCCH resource on the second component carrier, selectively receiving the feedback in parallel with uplink information based on whether parallel uplink transmission is enabled.

Aspect 52: The method of aspect 51, wherein the selectively receiving the feedback in parallel with the uplink information based on whether parallel uplink transmission is enabled comprises: receiving the feedback in parallel with physical uplink shared channel (PUSCH) information when parallel uplink transmission is enabled.

Aspect 53: The method of aspect 51, wherein the selectively receiving the feedback in parallel with the uplink information based on whether parallel uplink transmission is enabled comprises: receiving multiplexed feedback and physical uplink shared channel (PUSCH) information when parallel uplink transmission is not enabled.

Aspect 54: The method of aspect 51, wherein the selectively receiving the feedback in parallel with the uplink information based on whether parallel uplink transmission is enabled comprises: abstaining from receiving the feedback in parallel with the uplink information when parallel uplink transmission is not enabled.

Aspect 55: The method of any of aspects 51 through 54, wherein: the first component carrier is a primary component carrier; and the second component carrier is a secondary component carrier.

Aspect 56: The method of any of aspects 51 through 54, wherein: the second component carrier is a primary component carrier; and the first component carrier is a secondary component carrier.

Aspect 57: A user equipment comprising: a transceiver configured to communicate with a radio access network, a memory, and a processor communicatively coupled to the transceiver and the memory, wherein the processor and the memory are configured to perform any one of aspects 1 through 9.

Aspect 58: An apparatus configured for wireless communication comprising at least one means for performing any one of aspects 1 through 9.

Aspect 59: A non-transitory computer-readable medium storing computer-executable code, comprising code for causing an apparatus to perform any one of aspects 1 through 9.

Aspect 60: A network entity comprising: a transceiver, a memory, and a processor communicatively coupled to the transceiver and the memory, wherein the processor and the memory are configured to perform any one of aspects 11 through 19.

Aspect 61: An apparatus configured for wireless communication comprising at least one means for performing any one of aspects 11 through 19.

Aspect 62: A non-transitory computer-readable medium storing computer-executable code, comprising code for causing an apparatus to perform any one of aspects 11 through 19.

Aspect 63: A user equipment comprising: a transceiver configured to communicate with a radio access network, a memory, and a processor communicatively coupled to the transceiver and the memory, wherein the processor and the memory are configured to perform any one of aspects 21 through 29.

Aspect 64: An apparatus configured for wireless communication comprising at least one means for performing any one of aspects 21 through 29.

Aspect 65: A non-transitory computer-readable medium storing computer-executable code, comprising code for causing an apparatus to perform any one of aspects 21 through 29.

Aspect 66: A network entity comprising: a transceiver, a memory, and a processor communicatively coupled to the transceiver and the memory, wherein the processor and the memory are configured to perform any one of aspects 31 through 39.

Aspect 67: An apparatus configured for wireless communication comprising at least one means for performing any one of aspects 31 through 39.

Aspect 68: A non-transitory computer-readable medium storing computer-executable code, comprising code for causing an apparatus to perform any one of aspects 31 through 39.

Aspect 69: A user equipment comprising: a transceiver configured to communicate with a radio access network, a memory, and a processor communicatively coupled to the transceiver and the memory, wherein the processor and the memory are configured to perform any one of aspects 41 through 48.

Aspect 70: An apparatus configured for wireless communication comprising at least one means for performing any one of aspects 41 through 48.

Aspect 71: A non-transitory computer-readable medium storing computer-executable code, comprising code for causing an apparatus to perform any one of aspects 41 through 48.

Aspect 72: A network entity comprising: a transceiver, a memory, and a processor communicatively coupled to the transceiver and the memory, wherein the processor and the memory are configured to perform any one of aspects 51 through 56.

Aspect 73: An apparatus configured for wireless communication comprising at least one means for performing any one of aspects 51 through 56.

Aspect 74: A non-transitory computer-readable medium storing computer-executable code, comprising code for causing an apparatus to perform any one of aspects 51 through 56.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-23 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 5, 6, 13, 14, and 19 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment, comprising:
a transceiver;
a memory; and
a processor coupled to the transceiver and the memory, wherein the processor and the memory are configured to:
receive data on a first component carrier of a plurality of component carriers, the plurality of component carriers being associated with an uplink control channel group; and
receive a first indication that the user equipment is allowed to transmit feedback for the data on a second component carrier of the plurality of component carriers.

2. The user equipment of claim 1, wherein the processor and the memory are further configured to:
receive a radio resource control (RRC) message that includes the first indication on a per component carrier basis.

3. The user equipment of claim 1, wherein the processor and the memory are further configured to:
transmit the feedback on a physical uplink control channel (PUCCH) of the second component carrier after the receiving the first indication.

4. The user equipment of claim 3, wherein the processor and the memory are further configured to:
receive the data on a physical downlink shared channel (PDSCH) of the first component carrier.

5. The user equipment of claim 1, wherein the processor and the memory are further configured to:
receive a second indication that the user equipment is allowed to transmit the feedback for the data on a third component carrier of the plurality of component carriers; and
select between the second component carrier and the third component carrier for transmitting the feedback.

6. The user equipment of claim 5, wherein:
the first component carrier is a primary component carrier;
the second component carrier is a first secondary component carrier; and
the third component carrier is a second secondary component carrier.

7. The user equipment of claim 1, wherein the uplink control channel group comprises a physical uplink control channel (PUCCH) group for uplink carrier aggregation.

8. The user equipment of claim 1, wherein:
the second component carrier is a primary component carrier; and
the first component carrier is a secondary component carrier.

9. The user equipment of claim 1, wherein the processor and the memory are further configured to:
receive a first resource allocation, wherein the first resource allocation is for transmission of the feedback for the data on the first component carrier; and
receive a second resource allocation, wherein the second resource allocation is for transmission of the feedback for the data on the second component carrier of the plurality of component carriers.

10. (canceled)

10. A network entity, comprising:
a transceiver;
a memory; and
a processor coupled to the transceiver and the memory, wherein the processor and the memory are configured to:
transmit data to a user equipment on a first component carrier of a plurality of component carriers, the plurality of component carriers being associated with an uplink control channel group; and
transmit a first indication that the user equipment is allowed to transmit feedback for the data on a second component carrier of the plurality of component carriers.

11. The network entity of claim 10, wherein the processor and the memory are further configured to:
transmit a radio resource control (RRC) message that includes the first indication.

12. The network entity of claim 10, wherein the processor and the memory are further configured to:
receive the feedback on a physical uplink control channel (PUCCH) of the second component carrier after the transmitting the first indication.

13. The network entity of claim 12, wherein the processor and the memory are further configured to:
transmit the data on a physical downlink shared channel (PDSCH) of the first component carrier.

14. The network entity of claim 10, wherein the processor and the memory are further configured to:
transmit a second indication that the user equipment is allowed to transmit the feedback for the data on a third component carrier of the plurality of component carriers; and
receive the feedback on the second component carrier or the third component carrier.

15. The network entity of claim 14, wherein:
the first component carrier is a primary component carrier;
the second component carrier is a first secondary component carrier; and
the third component carrier is a second secondary component carrier.

16. The network entity of claim 10, wherein the uplink control channel group comprises a physical uplink control channel (PUCCH) group for uplink carrier aggregation.

17. The network entity of claim 10, wherein:
the second component carrier is a primary component carrier; and
the first component carrier is a secondary component carrier.

18. The network entity of claim 10, wherein the processor and the memory are further configured to:
transmit a first resource allocation, wherein the first resource allocation is for transmission of the feedback for the data on the first component carrier; and
transmit a second resource allocation, wherein the second resource allocation is for transmission of the feedback for the data on the second component carrier of the plurality of component carriers.

19. A user equipment, comprising:
a transceiver;
a memory; and
a processor coupled to the transceiver and the memory, wherein the processor and the memory are configured to:
receive data on a first component carrier of a plurality of component carriers, the plurality of component carriers being associated with an uplink control channel group;
receive a first resource allocation, the first resource allocation being for transmission of feedback for the data on the first component carrier; and
receive a second resource allocation, the second resource allocation being for transmission of the feedback for the data on a second component carrier of the plurality of component carriers.

20. (canceled)

20. The user equipment of claim 19, wherein:
the first resource allocation specifies a first set of physical uplink control channel (PUCCH) resources for the first component carrier; and
the second resource allocation specifies a second set of PUCCH resources for the second component carrier.

21. The user equipment of claim 19, wherein the processor and the memory are further configured to:
receive at least one radio resource control (RRC) configuration message that indicates the first resource allocation and the second resource allocation.

22. The user equipment of claim 19, wherein the processor and the memory are further configured to:
receive a third resource allocation, wherein the third resource allocation is for transmission of the feedback for the data on a third component carrier of the plurality of component carriers.

23. The user equipment of claim 22, wherein:
the first component carrier is a primary component carrier;
the second component carrier is a first secondary component carrier; and
the third component carrier is a second secondary component carrier.

24. The user equipment of claim 22, wherein the processor and the memory are further configured to:
transmit the feedback on the second component carrier or the third component carrier.

25. The user equipment of claim 19, wherein:
the first component carrier is assigned a first bandwidth; and
the second component carrier is assigned a second bandwidth that is different from the first bandwidth.

26. The user equipment of claim 19, wherein:
the second component carrier is a primary component carrier; and
the first component carrier is a secondary component carrier.

27. The user equipment of claim 19, wherein the processor and the memory are further configured to:
receive a first indication that the user equipment is allowed to transmit the feedback for the data on the second component carrier of the plurality of component carriers.

28. A network entity, comprising:
a transceiver;
a memory; and
a processor coupled to the transceiver and the memory, wherein the processor and the memory are configured to:
transmit data on a first component carrier of a plurality of component carriers, the plurality of component carriers being associated with an uplink control channel group;
transmit a first resource allocation, the first resource allocation being for transmission of feedback for the data on the first component carrier; and
transmit a second resource allocation, the second resource allocation being for transmission of the feedback for the data on a second component carrier of the plurality of component carriers.

29. The network entity of claim 28, wherein:
the first resource allocation specifies a first set of physical uplink control channel (PUCCH) resources for the first component carrier; and
the second resource allocation specifies a second set of PUCCH resources for the second component carrier.

30. (canceled)

30. The network entity of claim 28, wherein the processor and the memory are further configured to:
transmit at least one radio resource control (RRC) configuration message that indicates the first resource allocation and the second resource allocation.

34-56. (canceled)
